(19) United States
(12) Patent Application Publication
(10) Pub. No.: US 2026/0213855 A1
(43) Pub. Date: Jul. 23, 2026

(54) DUAL-LAYER QUANTUM COMMUNICATION AND INFORMATION PROCESSING USING TEMPORAL AND SPATIAL ENCODING

(71) Applicant: Homatch.ai, Milpitas, CA (US)

(72) Inventor: Mingjun Wang, Saratoga, CA (US)

(73) Assignee: Homatch.ai, Milpitas, CA (US)

(21) Appl. No.: 19/449,201

(22) Filed: Jan. 14, 2026

Related U.S. Application Data
(60) Provisional application No. 63/746,692, filed on Jan. 17, 2025.

(51) Int. Cl. H04B 10/70; B82Y 20/00

(52) U.S. Cl. CPC H04B 10/70; B82Y 20/00

(57) ABSTRACT

A method includes generating a photon and establishing a time-bin frame having a period T and multiple non-overlapping time bins of duration Δt. The method includes preparing a quantum state of the photon in a time-bin basis and in at least one additional quantum degree of freedom selected from polarization, OAM, and phase, thereby forming a composite quantum state. The method includes routing the photon to a selected emission point of a three-dimensional (3D) photonic structure having multiple emission points with respective spatial coordinates. The method includes synchronizing a sender and a receiver with a shared timing reference and time-gated detection windows aligned to the time bins, and emitting the photon from the selected emission point into a quantum channel. A combination of the time-bin state encoding quantum information and an emission-point coordinate associated with a spatial symbol and/or non-secret control metadata for protocol processing forms a composite codeword.

### RELATED APPLICATION

This application claims the benefit of and priority to U.S. Provisional Application No. 63/746,692 filed Jan. 17, 2025. The entire contents of the 63/746,692 application is hereby incorporated by reference in its entirety.

### TECHNICAL FIELD

The present disclosure relates generally to quantum computing and quantum communication and, more particularly, to methods and systems for dual-layer quantum encoding based on temporal (time-bin) and spatial dimensions in photonic structures.

### BACKGROUND

Unless otherwise indicated herein, the materials described herein are provided for background and context only. Such materials are not admitted to be prior art to the claims in the present application and are not admitted to be prior art by inclusion in this section.

Quantum computing and quantum communication technologies are transforming the way information is processed and transmitted by leveraging fundamental quantum-mechanical properties such as superposition and entanglement. Many existing quantum systems encode information using quantum states associated with a limited set of degrees of freedom, such as polarization, orbital angular momentum (OAM), and phase. While effective, such approaches may not fully exploit additional temporal and spatial dimensions inherently available in photonic quantum systems.

The subject matter claimed herein is not limited to embodiments that address any particular disadvantages or that operate only in environments such as those described above. Rather, this background is provided only to illustrate one example technology area in which some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some quantum communication and computation systems that rely solely on temporal encoding, such as time-bin encoding, face scalability challenges related to synchronization overhead, clock drift, and limited per-photon information density. Conversely, some systems that rely solely on spatial encoding, such as spatial modes or fixed emission locations, may encounter hardware scaling constraints, increased crosstalk, and mode-management complexity as system size increases. Accordingly, there is a need for quantum architectures that combine orthogonal temporal and spatial encoding dimensions in a coordinated manner to improve information density, scalability, and robustness without requiring prohibitive increases in system complexity.

Some embodiments herein relate to time-space dual encoding that combines discrete time bins (temporal layer) with spatial positions (geometric layer). The method may overlay quantum state modulation (e.g., phase, polarization, orbital angular momentum (OAM)) on the temporal and geometric layers to form composite quantum states. Some embodiments may further include a dynamic coupling mechanism to manage transitions across time bins and spatial nodes and/or may include applications for quantum key distribution (QKD), parallel quantum computing, and storage. Example embodiments may be implemented with or in a double-helix photonic structure or other three-dimensional (3D) photonic structure.

Various embodiments described herein involve dual-layer encoding using temporal time-bin states and spatial coordinates. Additional modulation dimensions, such as frequency modulation or amplitude modulation, may be employed in some implementations as optional auxiliary control, monitoring, or error-management mechanisms. Such additional modulation dimensions are not required for implementation of the dual time-space encoding framework and do not alter the fundamental encoding roles of the temporal and spatial layers.

In an example embodiment, a method for dual-layer quantum communication and computation includes generating a photon. The method includes establishing a time-bin frame having a period T and multiple non-overlapping time bins of duration Δt. The method includes preparing a quantum state of the photon in a time-bin basis and in at least one additional quantum degree of freedom selected from polarization, orbital angular momentum (OAM), and phase, thereby forming a composite quantum state. The method includes routing the photon to a selected emission point of a 3D photonic structure having multiple emission points with respective spatial coordinates. The method includes synchronizing a sender and a receiver with a shared timing reference and time-gated detection windows aligned to the time bins. The method includes emitting the photon from the selected emission point into a quantum channel. A time-bin state encodes quantum information, and an emission-point coordinate is associated with a spatial symbol and/or non-secret control metadata. The combination of the time-bin state and emission-point coordinate forms a composite codeword for protocol processing.

In another example embodiment, a dual-layer quantum communication system includes a photon source, a timing module, a 3D photonic structure, a dynamic coupling network, a modulator, and a receiver. The timing module is configured to define a time-bin frame with bin duration Δt and to distribute synchronization to the receiver. The 3D photonic structure has multiple emission points with unique spatial coordinates. The dynamic coupling network includes at least one variable optical delay and an optical switch to transition a photon between time bins and spatial paths. The modulator is configured to prepare a time-bin quantum state and at least one of polarization, OAM, or phase states. The receiver includes time-gated detectors and a spatial decoding module. The system encodes quantum information in the time-bin state and associates spatial symbols and/or non-secret control metadata with emission-point coordinates.

In another example embodiment, a method for dual-layer quantum communication and computation includes generating a photon. The method includes establishing a time-bin frame having a period T and a plurality of non-overlapping time bins of duration Δt. The method includes preparing a quantum state of the photon in a time-bin basis and in at least one additional quantum degree of freedom selected from polarization, OAM, phase, or frequency, thereby forming a composite quantum state. The method includes routing the photon to a selected spatial mode of a photonic structure having a plurality of distinguishable spatial modes. The method includes synchronizing a sender and a receiver. The method includes emitting the photon into a quantum channel. Information is encoded jointly using a temporal coordinate associated with the time-bin basis and a spatial coordinate associated with the selected spatial mode.

In another example embodiment, a dual-layer quantum communication system includes a photon source, a timing module, a photonic structure, a routing network, a modulator, and a receiver. The timing module is configured to define a time-bin frame. The photonic structure provides multiple distinguishable spatial modes. The routing network is configured to direct photons to selected spatial modes. The modulator is configured to prepare time-bin quantum states and at least one additional quantum degree of freedom. The receiver is configured to resolve both temporal and spatial coordinates of received photons.

In another example embodiment, discrete time-bin quantum states are combined with spatially addressable emission points of a three-dimensional photonic structure to form composite codewords, such that temporal and spatial coordinates jointly encode information while remaining independently resolvable at a receiver.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION

The present application can be best understood by reference to the embodiments described below taken in conjunction with the accompanying drawing figures, in which like reference numerals refer to like elements throughout.

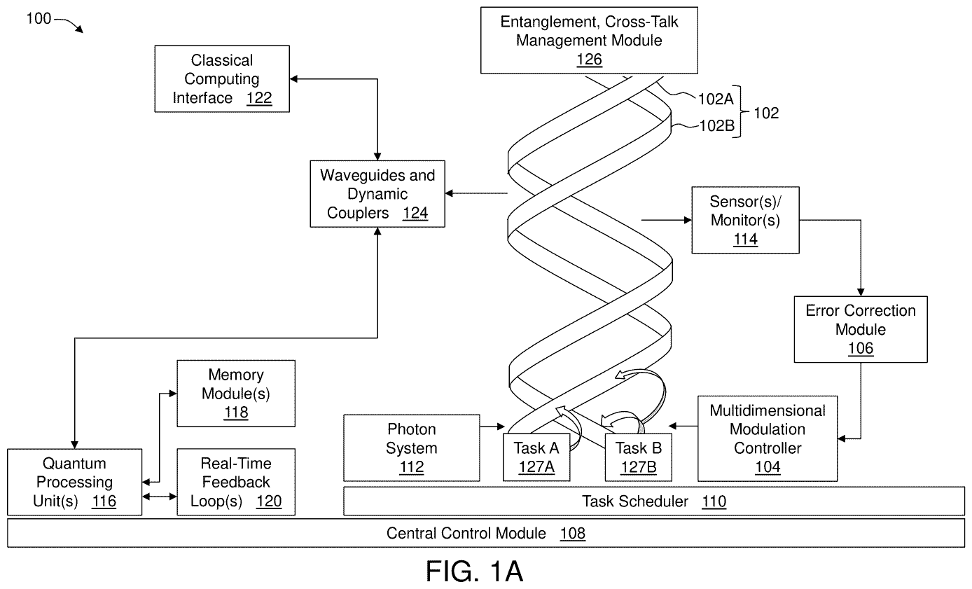

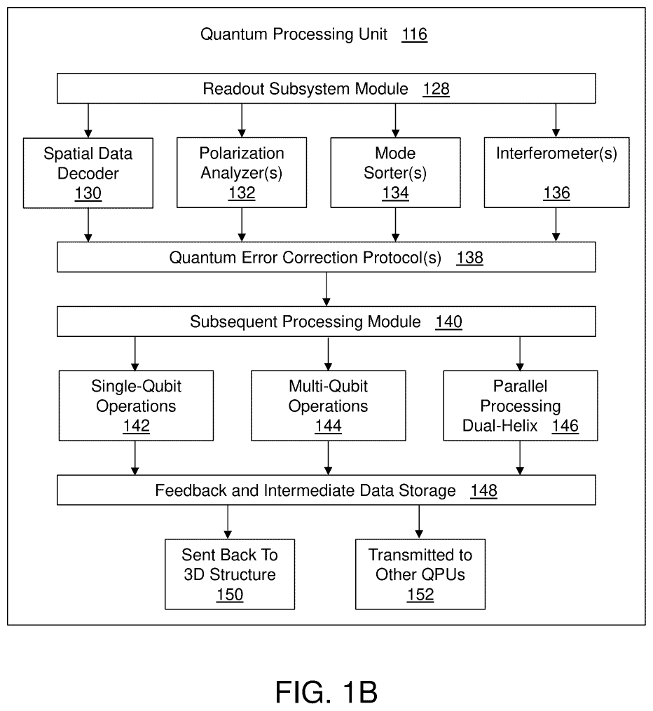

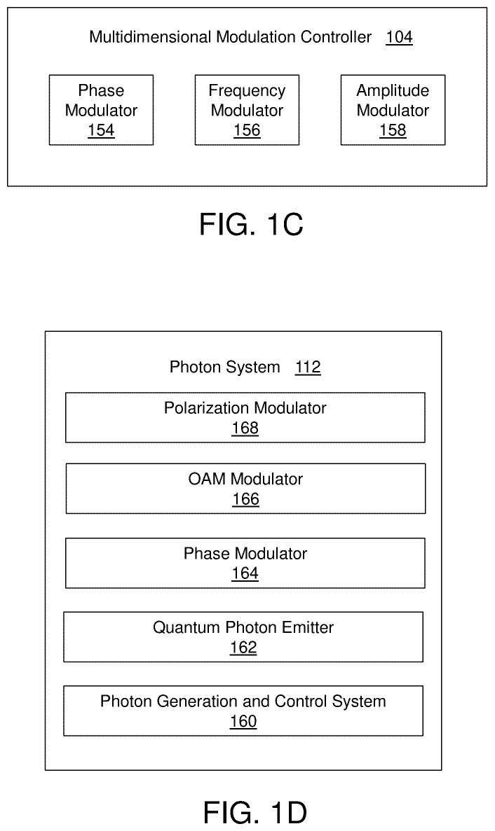

FIG. 1A illustrates an example quantum computing and communication system that includes a three-dimensional (3D) photonic structure.

FIG. 1B illustrates an example implementation of a quantum processing unit (QPU) included in the quantum computing system of FIG. 1A.

FIG. 1C illustrates an example implementation of a multidimensional modulation controller included in the quantum computing and communication system of FIG. 1A.

FIG. 1D illustrates an example implementation of a photon system included in the quantum computing and communication system of FIG. 1A.

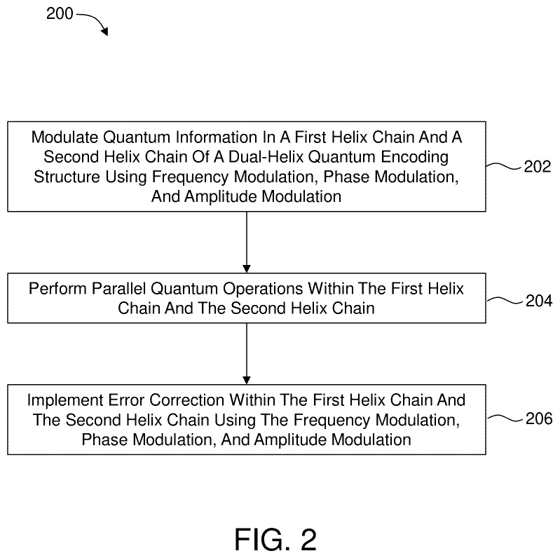

FIG. 2 depicts a flowchart of an example method for quantum computing.

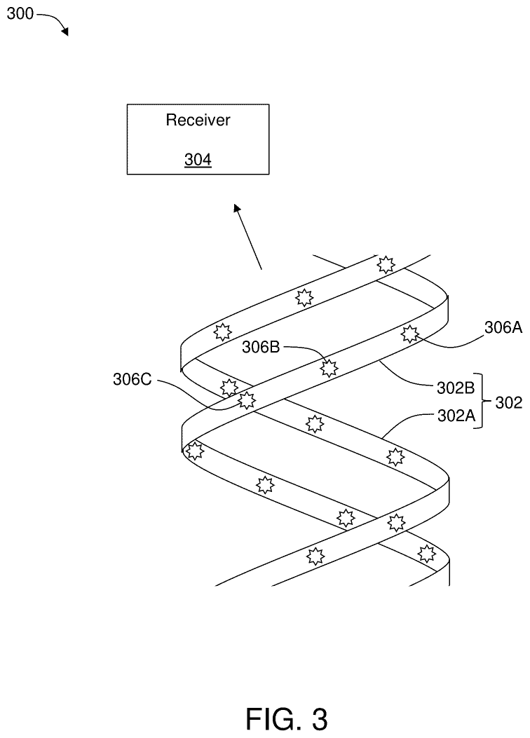

FIG. 3 illustrates an example quantum communication system that may be implemented for secure quantum communication using dual-layer time-space encoding.

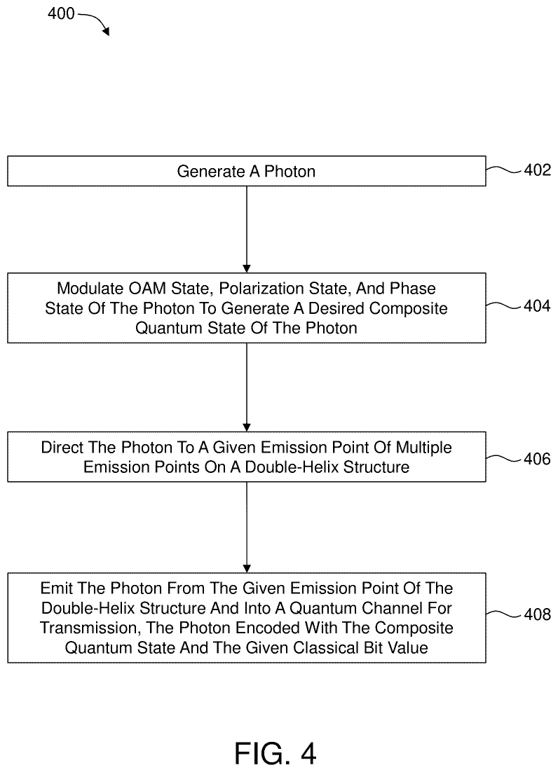

FIG. 4 depicts a flowchart of an example method for secure quantum communication.

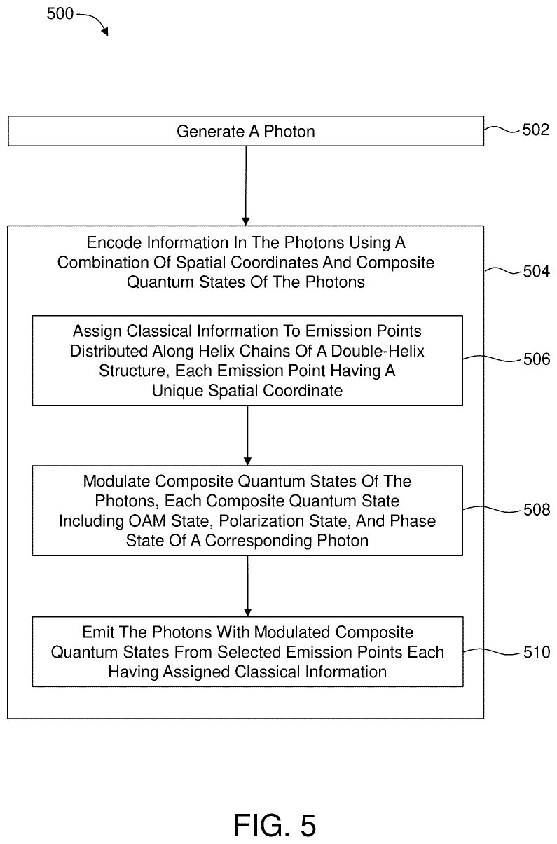

FIG. 5 depicts a flowchart of another example method for secure quantum communication.

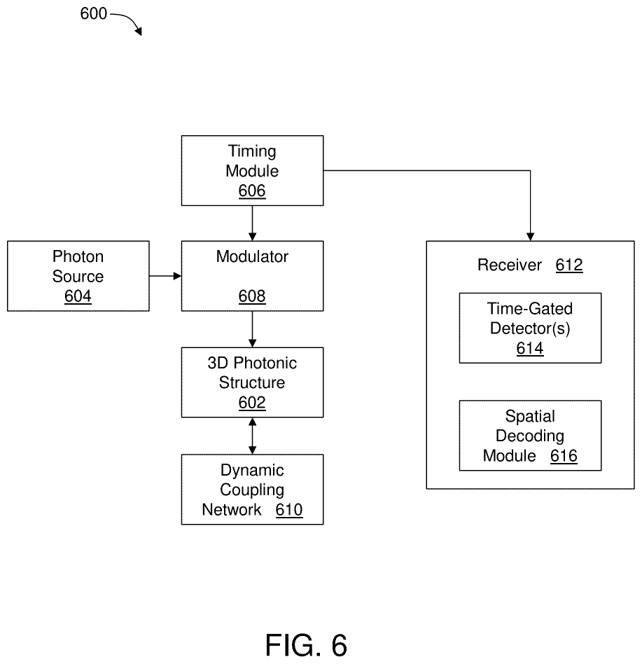

FIG. 6 illustrates another example quantum computing and communication system that includes a three-dimensional photonic structure.

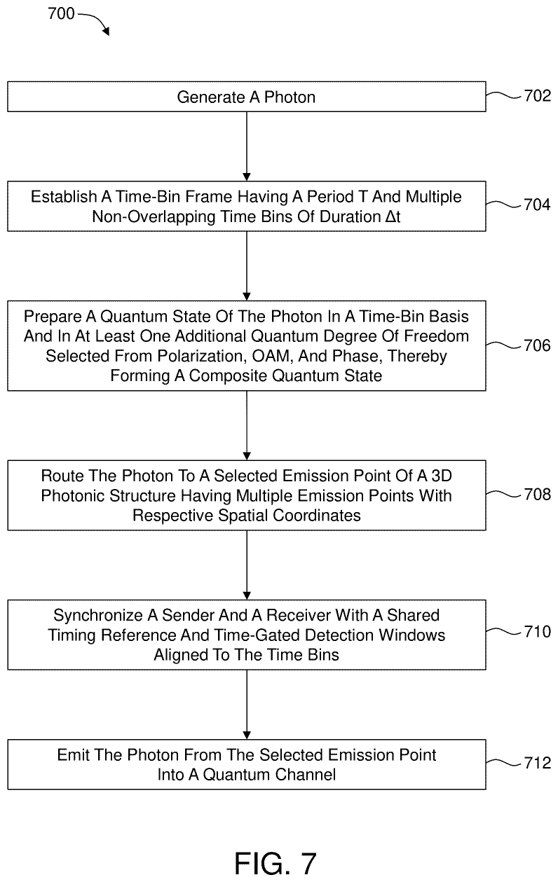

FIG. 7 depicts a flowchart of an example method for dual-layer quantum communication and computation.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

Example embodiments herein involve a dual encoding method and system that jointly encode information in discrete time bins and spatial node positions within a three-dimensional photonic structure, with photons additionally modulated in quantum degrees of freedom (e.g., polarization, orbital angular momentum (OAM), and phase) to form a composite quantum state. A dynamic coupling mechanism may transition photons between time bins and spatial nodes under synchronized control, enabling high-dimensional quantum key distribution (QKD), parallel quantum operations (e.g., time bins as processing cycles), and quantum information storage (e.g., time bins as memory cells with spatial redundancy).

Embodiments herein will first be described in the context of secure communication methods and systems with respect to FIGS. 1A-5, which are generally anchored to a photonic structure with discrete emission points. Security may arise from composite quantum-state modulation (e.g., OAM, polarization, and/or phase), together with spatial symbol association and protocol-level processing (e.g., sifting and reconciliation), rather than from spatial coordinates alone.

The embodiments described with respect to FIGS. 1A-5 primarily involve a double-helix or helical three-dimensional photonic structure for a spatial emission architecture. However, it is explicitly contemplated that other photonic structures may be implemented, including linear chains, planar grids, radial layouts, circular loops, spiral arms, and/or arbitrary two-dimensional (2D) or three-dimensional (3D) arrays to support the same composite encoding principles. Each emission point in these alternative geometries or arrangements may remain uniquely identifiable by spatial coordinate and independently addressable via a system control module, while spatial coordinates are used for spatial symbol association and/or non-secret control metadata. These alternatives may offer compatibility with planar photonic platforms or chip-scale integration.

The embodiments of FIGS. 1A-5 may be extended to time-space dual encoding, as described in more detail with respect to FIGS. 6-7, involving orthogonal time-bin and spatial layers plus the quantum state, with a control stack for inter-layer routing. The time-space dual encoding may involve applications for QKD, compute, and/or storage. Alternatively or additionally, the time-space dual encoding may include synchronization and binning, temporal gating, and dynamic couplers/switches.

FIGS. 1A-1D illustrate an example system context that includes a 3D photonic structure in the form of a double-helix photonic structure. It should be understood that FIGS. 1A-1D illustrate an example system context in which the disclosed dual-layer time-space encoding may be implemented. Some inventive concepts described herein do not require the presence of all modules shown, and various subsystems illustrated in FIGS. 1A-1D may be omitted, combined, or implemented externally without departing from the scope of the invention.

FIG. 1A illustrates an example quantum computing system 100 (hereinafter “system 100”) that includes a 3D photonic structure, arranged in accordance with at least one embodiment herein. In particular, the system 100 includes a 3D photonic structure 102 in the form of a double-helix photonic structure, a multidimensional modulation controller 104 (hereinafter “controller 104”), and an error correction module 106. The system 100 may further include a central control module 108, a task scheduler 110, a photon system 112, one or more sensors or monitors 114 (hereinafter generically “sensors 114” or “sensor 114”), one or more quantum processing units (QPUs) 116, one or more memory modules 118, one or more real-time feedback loops 120, a classical computing interface 122, one or more waveguides and/or dynamic couplers 124, and an entanglement and cross-talk management module 126 (hereinafter “entanglement module 126”).

In general, the three-dimensional photonic structure 102 may include multiple emission points with unique spatial coordinates. In the example of FIG. 1A, the emission points are distributed along a first helix chain 102A and a second helix chain 102B. Each of the first helix chain 102A and the second helix chain 102B may include at least one of high-transparency quartz, fused silica, silicon nitride (SiN), lithium niobate (LiNbO₃), or other suitable materials. The controller 104 may be configured to modulate quantum information in the first and second helix chains 102A, 102B using two or more of frequency modulation, phase modulation, and amplitude modulation. The three-dimensional photonic structure 102 may be configured to perform parallel quantum operations within the first helix chain 102A and the second helix chain 102B under control of the central control module 108 and/or the task scheduler 110. The error correction module 106 may be configured to implement error detection and correction mechanisms associated with modulation control, synchronization, and protocol-level processing within the first and second helix chains 102A, 102B.

The helix chains 102A, 102B may operate in parallel, each processing different quantum tasks simultaneously. The architecture of the system 100 may dynamically assign tasks to different chains 102A, 102B based on the complexity of the computations. In some embodiments, this may ensure balanced load distribution. For example, FIG. 1A depicts two example tasks 127A, 127B assigned to the helix chains 102. In this example, the task 127A is a relatively simple task assigned completely to the second helix chain 102B, while the task 127B is more complex and is divided up with a larger portion being assigned to the first helix chain 102A and a smaller portion being assigned to the second helix chain 102B. Such an assignment and division of tasks may balance load distribution, e.g., the task 127A and smaller portion of the task 127B assigned to the second helix chain 102B may be approximately equal to the larger portion of the task 127B assigned to the first helix chain 102A in this example.

The task scheduler 110 may manage the distribution of quantum computing tasks across the helix chains 102A, 102B, which may optimize the processing power of the system 100 in some embodiments. The task scheduler 110 may also monitor frequency, phase, and/or amplitude variations across the helix chains 102A, 102B to ensure synchronized operation. Alternatively or additionally, the task scheduler 110 may perform load balancing across the first and second helix chains 102A, 102B.

The system 100 may monitor, for example continuously or periodically, modulated dimensions such as frequency, phase, and amplitude associated with the helix chains 102A, 102B. For example, the sensors 114 may monitor modulation parameters of each of the first and second helix chains 102A, 102B. If one modulated dimension experiences a deviation (e.g., a phase drift), the system 100 may detect the deviation through real-time monitoring by the sensors 114 and may apply corrective adjustments using one or more other modulation dimensions and/or control mechanisms, for example via the error correction module 106, to restore an intended quantum state or maintain quantum state coherence.

In some embodiments, one or more quantum or quantum-inspired error mitigation techniques may be implemented by the error correction module 106 to utilize redundancy provided by multidimensional modulation. For example, if a deviation occurs in a frequency modulation parameter, phase and/or amplitude parameters may be adjusted to compensate for the deviation and maintain coherence of the quantum state.

As an illustrative example, the system 100 may utilize multiple modulation dimensions (e.g., frequency, phase, and amplitude) to detect and mitigate errors. For instance, if one helix chain 102A or 102B exhibits a frequency deviation due to noise or environmental fluctuation, the sensors 114 and/or the error correction module 106 may detect the deviation through corresponding changes in phase or amplitude. The system 100 may then dynamically adjust phase and/or amplitude parameters to mitigate the detected deviation and maintain coherence. Such error mitigation may reduce propagation of disturbances through the system 100.

The performance characteristics of a quantum computing and communication system that includes a double-helix photonic structure, such as the three-dimensional photonic structure 102, may differ from those of systems relying on a single modulation dimension. The following performance characteristics are provided as illustrative, non-limiting examples based on simulations and modeling under idealized or controlled conditions. Actual performance may vary depending on implementation parameters, noise sources, and operating environments, and the disclosed systems are not limited to achieving specific numerical performance values. Simulations conducted by the inventors indicate that parallel processing enabled by multidimensional modulation and multiple helix chains may improve effective throughput and error detection capability under certain conditions.

In an example implementation, the classical computing interface 122 of FIG. 1A may be configured to receive classical data input. The classical computing interface 122 may convert the classical data input into quantum information suitable for processing by the three-dimensional photonic structure 102 and/or one or more QPUs 116. The classical computing interface 122 may transmit the quantum information to the controller 104 for modulation and processing in the first and second helix chains 102A, 102B, and may convert quantum processing results back into classical data output.

The double-helix quantum encoding architecture embodied in the system 100 of FIG. 1 may serve as a foundation for transmitting, receiving, and decoding quantum-encoded photons. The system 100 may support encoding and transmission functionalities as well as quantum processing and memory or storage integration. Alternatively or additionally, the system 100 may support dual encoding in time and space for QKD, computation, and/or storage applications.

The system 100 may include or support quantum gates and circuits for performing operations on qubits associated with the helix chains 102A, 102B, examples of which are described with respect to FIG. 1B. Processing may occur at designated quantum nodes along each helix chain 102A, 102B, where modulation of frequency, phase, and amplitude using the controller 104 may enable operations such as quantum logic gates (e.g., CNOT, Hadamard).

The parallel nature of the helix chains 102A, 102B may allow for concurrent quantum computations. The task scheduler 110 may dynamically assign tasks across the helix chains 102A, 102B to optimize or improve computational throughput under given operating conditions.

Nodes within the three-dimensional photonic structure 102 may act as quantum memory elements, storing quantum states encoded via phase, time-bin, or other supported modulation dimensions.

Multidimensional modulation, for example as provided by the controller 104, may provide redundancy for error detection and mitigation, contributing to stability of stored or transmitted quantum information against decoherence or environmental noise. As used herein, time-bin encoding provides a temporal coordinate for the dual-layer encoding framework. Frequency modulation and amplitude modulation, where described, may be employed as optional auxiliary dimensions for control, monitoring, decoy-state selection, or error-management purposes and are not required for implementation of the dual time-space encoding framework.

The use of multiple helix chains 102A, 102B in the three-dimensional photonic structure 102 may increase effective storage density and parallelism, allowing the system 100 to handle larger quantum datasets or intermediate results.

The double-helix quantum encoding architecture depicted in FIG. 1A may be combined with conventional computing systems to create a hybrid quantum-classical system. For example, the classical computing interface 122 may receive classical data inputs and convert them into quantum-encoded information for processing, and may transmit quantum computation results back as classical data outputs. Such hybrid systems may enable classical processors to manage scheduling, optimization, and error mitigation tasks and/or to handle preprocessing and postprocessing of quantum states.

Example hybrid quantum-classical use cases include data preprocessing, postprocessing, and optimization tasks. For instance, classical systems may preprocess classical data before encoding it into quantum states and postprocess quantum results after measurement to reduce noise or refine output data. Alternatively or additionally, classical systems may operate iteratively alongside quantum processors for quantum machine learning or variational quantum algorithms.

Hybrid approaches as described herein may leverage complementary strengths of classical and quantum computing components, with quantum components handling high-dimensional state manipulation and classical components providing control, stability, and error mitigation.

FIG. 1B illustrates an example implementation of the QPU 116 of FIG. 1A. As illustrated, the QPU 116 may include a readout subsystem module 128, a spatial data decoder 130, one or more polarization analyzers 132, one or more mode sorters 134, one or more interferometers 136, one or more error detection or mitigation modules 138, a subsequent processing module 140, one or more single-qubit operations 142, one or more multi-qubit operations 144, a parallel processing double-helix 146, and feedback and intermediate data storage 148.

FIG. 1C illustrates an example implementation of the controller 104 of FIG. 1A. The controller 104 may modulate phase, frequency, and/or amplitude of photons traveling within each helix chain 102A, 102B in real time to support controlled quantum state preparation and routing.

As illustrated, the controller 104 may include a phase modulator 154, a frequency modulator 156, and/or an amplitude modulator 158. The controller 104 may modulate properties of individual photons or qubits processed within the three-dimensional photonic structure 102, while the structure itself remains a stable architectural framework.

In this and other embodiments, the three-dimensional photonic structure 102 may be designed to support information processing capacity by incorporating multiple modulation dimensions, including phase, frequency, and amplitude.

For example, each helix chain 102A, 102B may operate with modulation parameters in a selected frequency range (e.g., 1 GHz to 10 GHz) used to support control, monitoring, or auxiliary quantum-state modulation. In such embodiments, frequency modulation may be used as a control or frequency-bin encoding parameter rather than as an optical carrier frequency.

Alternatively or additionally, a frequency monitoring and control system may be implemented using the frequency modulator 156 together with one or more sensors 114 and/or the error correction module 106. The frequency monitoring and control system may ensure that frequency modulation across the helix chains 102A, 102B remains within a predetermined range and may apply corrective adjustments when deviations are detected.

Phase modulation, as implemented by the phase modulator 154, may be used to control relative optical phase and interference conditions associated with photons traveling within the three-dimensional photonic structure 102. In some embodiments, such phase control may be used to prepare, adjust, or stabilize coherent superposition states in interferometric or multi-path implementations (e.g., by controlling relative phase between two or more paths or modes). The phase modulator 154 may control phase across the system 100 by modulating phase of photons or qubits within the three-dimensional photonic structure 102, thereby supporting synchronization and coherent operation.

Alternatively or additionally, a phase coupling mechanism may be implemented using the phase modulator 154, together with one or more sensors 114, and/or the error correction module 106. The phase coupling mechanism may ensure phase synchronization between the helix chains 102A, 102B to reduce computational errors caused by phase misalignment. The phase coupling mechanism may detect phase drifts (e.g., using a phase sensor of the sensors 114) and correct misalignment by adjusting the phase of the affected helix chain 102A, 102B via the error correction module 106 and/or the phase modulator 154 of the controller 104. The phase synchronization across the helix chains 102A, 102B may minimize, or at least reduce, computational errors due to, e.g., phase misalignment between the helix chains 102A, 102B.

Amplitude modulation, as implemented by the amplitude modulator 158, may be used to support error detection and mitigation and/or link-quality management. By dynamically adjusting amplitude, the system 100 may compensate for loss variations, stabilize signal levels, and support monitoring or auxiliary control functions in the presence of environmental disturbances. The amplitude modulator 158 may control amplitude across the system 100 by modulating amplitude of photons or qubits within the three-dimensional photonic structure 102.

FIG. 1D illustrates an example implementation of the photon system 112 of FIG. 1A, arranged in accordance with at least one embodiment herein. As illustrated, the photon system 112 of FIG. 1D may include a photon generation and control system 160, a quantum photon emitter 162, a phase modulator 164, an orbital angular momentum (OAM) modulator 166, and/or a polarization modulator 168. In general, each of the phase modulator 164, the OAM modulator 166, and the polarization modulator 168 may be configured to modulate, respectively, the phase, the OAM, and the polarization of photons that the photon system 112 provides to the 3D photonic structure 102 of FIG. 1A.

In some embodiments, the system 100 with its various components as depicted in FIGS. 1A-1D, may operate generally as follows. Referring to FIGS. 1A and 1C, the controller 104 may modulate properties of each of the first and second helix chains 102A, 102B of the 3D photonic structure 102 of FIG. 1A. For example, the phase modulator 154 (FIG. 1C) of the controller 104 may modulate the phase of each of the first and second helix chains 102A, 102B. The frequency modulator 156 (FIG. 1C) of the controller 104 may modulate the frequency of photons traveling within each of the first and second helix chains 102A, 102B. The amplitude modulator 158 (FIG. 1C) of the controller 104 may modulate the amplitude of each of the first and second helix chains 102A, 102B.

Referring to FIGS. 1A and 1D, the photon system 112 may generally generate single photons and provide them to the 3D photonic structure 102. In more detail, the photon generation and control system 160 may generate photons which may be emitted by the quantum photon emitter 162. Quantum information (e.g., input data for a computation) may be encoded into each photon by modulating one or more of each photon's phase, OAM, and/or polarization, e.g., using the phase modulator 164, the OAM modulator 166, and/or the polarization modulator 168. The phase modulator 164, the OAM modulator 166, and the polarization modulator 168 are depicted as being part of the photon system 112 that is external to the 3D photonic structure 102. In other embodiments, the phase modulator 164, the OAM modulator 166, and/or the polarization modulator 168 may be integrated into the 3D photonic structure 102, e.g., to modulate photon properties during computation rather than beforehand.

The OAM modulator 166 may encode high-dimensional information by modulating the OAM of each photon. For example, a photon may be assigned OAM values of +1, −1, or higher-order modes. These states may correspond to distinct quantum information channels, increasing encoding capacity.

The polarization modulator 168 may encode binary quantum states by modulating photon polarization. For example, horizontal or vertical polarization may represent binary quantum states |0 [symbol] or |1 [symbol] . Circular polarization states (left or right) may be used for alternative qubit encoding schemes (e.g., polarization-entangled qubits).

The phase modulator 164 may add extra encoding layers for complex state representation. For example, photons may be modulated to include arbitrary phase values, which may enhance the encoding of multi-qubit states. Alternatively or additionally, this may enable interference-based quantum computing and multi-photon entanglement schemes. In some embodiments, the phase modulator 164 is implemented as part of the photon system 112 for pre-modulation of photons prior to entry into the three-dimensional photonic structure 102; alternatively, a phase modulator having the same or similar functionality may be implemented within a QPU 116 to perform localized phase adjustments for specific operations.

The waveguides and dynamic couplers 124 are depicted in FIG. 1A as being external to the 3D photonic structure 102. In other embodiments, one or more of the waveguides and/or dynamic couplers 124 may be integrated directly into and/or embedded within the 3D photonic structure 102, facilitating internal routing of encoded photons between processing nodes. Encoded photons (e.g., modulated in phase, OAM, and/or polarization) may be routed through free-space and/or waveguides embedded in the 3D photonic structure 102. Dynamic couplers may selectively direct encoded photons to an appropriate processing unit (e.g., any of the QPUs 116). The waveguides and dynamic couplers may include or be included in the waveguides and dynamic couplers 124 of FIG. 1A, for instance. The waveguides and dynamic couplers (whether external to and/or integrated within the 3D photonic structure 102) may ensure efficient quantum state transfer between subsystems.

Referring to FIGS. 1A-1B, each QPU 116 includes a subsystem, such as the readout subsystem module 128, to detect and decode photons. The readout subsystem module 128 may include the spatial data decoder 130, the polarization analyzer 132, the mode sorter 134, and/or the interferometer 136. The readout subsystem module 128 may detect the incoming photons (received from the 3D photonic structure 102 via the waveguides and dynamic couplers 124) and extract quantum states using, e.g., the polarization analyzer 132 to detect polarization of each photon, the mode sorter 134 to detect OAM of each photon, and/or the interferometer 136 to detect the phase of each photon. The extracted quantum states may be mapped to qubits in the QPU 116 for subsequent processing. Alternatively or additionally, non-secret spatial control information and/or spatial symbol information associated with the spatial location (e.g., emission point 306 or spatial port) of each photon at the three-dimensional photonic structure 102 may be extracted by the spatial data decoder 130 when the photons are received at the QPU 116, for use in protocol processing (e.g., synchronization, routing verification, decoy processing, basis reconciliation, and/or post-sifting symbol mapping), as described in further detail below.

The quantum error correction protocols 138 may be applied, in some embodiments (e.g., where intermediate storage nodes, purification stages, or repeater functionality are employed), to support integrity of stored or processed quantum states during transmission, routing, and decoding. The quantum error correction protocols 138 may be part of and/or implemented by the error correction module 106 of FIG. 1A. The quantum error correction protocols 138 may be an internal component or implementation of the broader error correction module 106. The QPU 116 may execute the quantum error correction protocols 138 as part of its quantum processing. Higher level error correction functionality (e.g., system wide monitoring, real time adjustments, and redundancy-based corrections) may be managed by error correction module 106. The error correction module 106 may oversee the entire 3D photonic structure 102, whereas the quantum error correction protocols 138 may focus more specifically on correcting individual qubit errors within the QPU 116. Thus, in some embodiments, the error correction module 106 in FIG. 1A encompasses the quantum error correction protocols 138 in FIG. 1B, integrating them into the system 100.

The subsequent processing module 140 may include the single-qubit operations 142, the multi-qubit operations 144, and/or the parallel processing double-helix 146. The QPU 116 may perform single-qubit gate operations 142 (e.g., X, Z, Hadamard gates) to manipulate individual qubits based on a given computation task. For example, a Hadamard gate may be implemented in the single-qubit operations 142 by the subsequent processing module 140 to create a superposition state from an input state. The QPU 116 may perform multi-qubit gate operations 144 to, e.g., entangle qubits or perform conditional operations. For example, a CNOT gate may be implemented in the multi-qubit operations 144 by the subsequent processing module 140 to flip a target qubit's state based on a control qubit's state. The QPU 116 may leverage the parallel nature of the parallel processing double-helix 146 (which may have a same or similar configuration as the 3D photonic structure 102 of FIG. 1A) to perform operations on multiple qubits simultaneously, distributed across helix chains. The QPU 116 may also execute multi-qubit gate operations 144, such as CNOT gates, Toffoli gates, and/or other gates. CNOT gates flip a target qubit's state based on a control qubit's state. Toffoli gates (and/or CCNOT gates) may be implemented for complex multi-qubit conditional logic. Alternatively or additionally, the QPU 116 may leverage the parallel processing double-helix 146 (which may have a similar or identical configuration to the 3D photonic structure 102 of FIG. 1A) to perform simultaneous quantum operations distributed across multiple qubits and helix chains.

Processed quantum states generated by the subsequent processing module via the single-qubit operations 142, the multi-qubit operations 144, and/or the parallel processing double-helix 146 may be sent back to the 3D photonic structure 102 of FIG. 1A for storage or further routing, as indicated at block 150, and/or transmitted to other QPUs 116 for additional computation, as indicated at block 152. Quantum memory modules, such as the memory module 118 of FIG. 1A, may store intermediate results or checkpointed states for multi-step computations.

Referring to FIG. 1A, the central control module 108 may coordinate data flow between the 3D photonic structure 102 and the QPUs 116, and may ensure that operations are synchronized. The central control module 108 may dynamically allocate QPU resources based on task priority and node availability. The real-time feedback loops 120 may monitor photon fidelity, gate execution, and/or routing efficiency. Adjustments may be made dynamically, e.g., as part of the real-time feedback loops 120, to minimize losses and optimize performance.

An example use case of the system 100 of FIG. 1A may involve solving a combinatorial optimization problem using the Variational Quantum Eigensolver (VQE) and may involve encoding, processing, iteration, and output. For encoding, input problem parameters may be encoded into photons within the 3D photonic structure, e.g., using the photon system 112 (or more specifically the phase modulator 164, the OAM modulator 166, and the polarization modulator 168 of FIG. 1D). For processing, the QPU 116 may execute quantum circuits (e.g., in the subsequent processing module 140 of FIG. 1B) to compute energy states. Intermediate results may be routed back to the 3D photonic structure 102 for temporary storage. For iteration, a classical computing system, which may be accessed via the classical computing interface 122 of FIG. 1A, may optimize parameters based on quantum results to update the encoding for subsequent iterations. For output, an optimized solution may be extracted after several iterations.

Integration of the 3D photonic structure 102 in or with any of the QPUs 116 may include one or more of the following advantages. First, multiple quantum operations may be executed simultaneously across distributed nodes in the 3D photonic structure 102. Second, multi-dimensional quantum states may enable compact and efficient data representation. Third, the modular nature of the double-helix architecture may support the addition of more nodes and QPUs 116 as computational demands grow. Fourth, redundant encoding and real-time error correction may ensure robust operations in noisy quantum environments.

Quantum superposition is a fundamental principle of quantum mechanics that allows a quantum system to exist in a coherent combination of multiple states simultaneously. In quantum information processing, superposition enables a qubit to represent a superposition of logical states (e.g., 0 and 1) rather than being restricted to a single definite state as in classical information systems. This property supports quantum communication and computation primitives, including interference-based measurements and entanglement-based protocols, in certain implementations.

In the system 100 of FIG. 1A, superposition states may be prepared and controlled using interferometric structures and phase modulation associated with quantum states in the three-dimensional photonic structure 102. For example, a phase modulator may control a relative phase between two or more paths or modes to prepare or stabilize a desired superposition, such as (/0 [symbol] +/1 [symbol] )/\sqrt{2}, where |0 [symbol] ∧|1 [symbol] are the basis states, in an appropriate encoding basis

The system 100 of FIG. 1A may leverage superposition in one or more of the following ways:

Phase modulation (e.g., by the phase modulator 154) may be used to control relative phase and interference conditions associated with optical paths or modes within each helix chain 102A, 102B. By adjusting relative phase between two or more paths or modes (e.g., in an interferometric or multi-path implementation), the system 100 may prepare and control superposition states.

The parallel nature of the 3D photonic structure 102 may allow for simultaneous preparation and manipulation of superposition states across different helix chains 102A, 102B, thereby supporting concurrent quantum operations.

The error correction module 106 may utilize measured syndromes, calibration signals, and/or error-mitigation techniques to detect and mitigate errors. In some embodiments, the system may employ states or measurements that are sensitive to specific error mechanisms to identify and reduce the impact of quantum noise and decoherence.

Superposition may be employed in the QPUs 116 to perform quantum logic operations on the encoded states. These operations may include creating superpositions, entangling qubits, and implementing quantum gates.

Quantum memory modules, such as the memory modules 118, may store superposed states, allowing for the preservation of quantum information between processing steps.

By incorporating superposition into various aspects of the system 100, the system 100 may support quantum information processing operations that are not available in purely classical systems, including interference-based measurements, entanglement-based protocols, and multi-degree-of-freedom state control.

The double-helix quantum encoding architecture of the system 100 of FIG. 1A may provide improvements in one or more of information storage and processing capacity, parallel operation capability, and/or robustness through monitoring and error mitigation. For example, multidimensional modulation may increase effective information density under certain operating conditions. The parallel design of the helix chains 102A, 102B may support concurrent execution of multiple tasks. Additionally, the multidimensional modulation and coupling mechanisms of the system 100 may support error detection and mitigation to improve stability in noisy environments.

FIG. 2 depicts a flowchart 200 of a method for quantum computing, arranged in accordance with at least one embodiment described herein. The method of FIG. 2 illustrates an optional implementation context in which frequency and amplitude modulation may be employed in conjunction with, but not as a substitute for, the disclosed time-bin and spatial encoding. The method 200 may be programmably performed or controlled by a processor in, e.g., a computer and/or server coupled to the classical computing interface 122. In an example implementation, the method 200 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 200 of FIG. 2. The method 200 may include one or more of blocks 202, 204, and/or 206.

At block 202, the method 200 may include modulating quantum information in a first helix chain and a second helix chain of a double-helix quantum encoding structure using frequency modulation, phase modulation, and amplitude modulation. For example, block 202 may include the controller 104, and specifically the phase modulator 154, frequency modulator 156, and/or amplitude modulator 158, modulating quantum information in the first helix chain 102A and the second helix chain 102B of the 3D photonic structure 102. Block 202 may be followed by block 204.

At block 204, the method 200 may include performing parallel quantum operations within the first helix chain and the second helix chain. For example, block 204 may include the 3D photonic structure performing parallel quantum operations within the first helix chain 102A and the second helix chain 102B as described with respect to the 3D photonic structure 102 of FIG. 1A and/or the parallel processing double-helix 146 of FIG. 1B. Block 204 may be followed by block 206.

At block 206, the method 200 may include implementing error detection and mitigation within the first helix chain and the second helix chain using frequency modulation, phase modulation, and amplitude modulation. For example, block 206 may include the error correction module 106, in whole or in part, implementing error detection and mitigation within the first helix chain 102A and the second helix chain 102B.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, the method 200 may further include detecting phase drift between the first helix chain and the second helix chain, e.g., by a phase sensor of the sensors 114. In response to detecting the phase drift, the method 200 may further include synchronizing phases across the first helix chain and the second helix chain. Synchronizing the phases may be performed by the error correction module 106 and/or the controller 104 (or specifically the phase modulator 154). In some embodiments, synchronizing phases across the first helix chain and the second helix chain may reduce computational errors due to phase misalignment between the first helix chain and the second helix chain.

As another example, the method 200 may further include monitoring frequency modulation across the first helix chain and the second helix chain to detect frequency deviations in the first helix chain or the second helix chain. In response to detecting a frequency deviation, the method 200 may further include adjusting frequency of one or both of the first helix chain or the second helix chain to realign quantum states in the first helix chain and the second helix chain.

As another example, the method 200 may further include distributing quantum computing tasks across the first helix chain and the second helix chain. The method 200 may further include performing load balancing across the first helix chain and the second helix chain.

As another example, the method 200 may further include detecting errors in at least one of frequency modulation, phase modulation, or amplitude modulation in the first helix chain or the second helix chain. In response to detecting the errors, the method 200 may further include correcting detected errors using unaffected modulation dimensions to maintain quantum state coherence.

As another example, modulating quantum information at block 202 may include modulating frequency, phase, and amplitude of each of the first helix chain and the second helix chain in real-time. Alternatively or additionally, modulating quantum information at block 202 may include preventing overlap or signal degradation between the first helix chain and the second helix chain.

In some embodiments, frequency modulation may be used for control, monitoring, synchronization, or frequency-bin encoding in appropriate implementations. Phase modulation may be used to control relative phase and interference conditions associated with superposition in multi-path or interferometric implementations. Amplitude modulation may support monitoring, link-quality management, and/or error-mitigation functions.

Alternatively or additionally, the method 200 may further include encoding quantum bits in the double-helix quantum encoding structure using the frequency modulation, phase modulation, and amplitude modulation. Alternatively or additionally, the method 200 may further include processing multiple quantum states simultaneously using the frequency modulation, phase modulation, and amplitude modulation.

FIG. 3 illustrates an example quantum communication system 300 (hereinafter “system 300”) that may be implemented for secure quantum communication, arranged in accordance with at least one embodiment described herein. The system 300 may include a quantum computing system, such as the system 100 and/or the 3D photonic structure 102 of FIG. 1A, and a receiver 304.

For example, as illustrated, the system 300 includes a 3D photonic structure 302 that may include, be included in, or correspond to the 3D photonic structure 102 of FIG. 1A. The 3D photonic structure 302 includes both a first helix chain 302A and a second helix chain 302B. The 3D photonic structure 302 may have a same or similar configuration as the 3D photonic structure 102. Further, the 3D photonic structure 302 includes multiple emission points 306A, 306B, 306C (hereinafter collectively “emission points 306” or generically “emission point 306”), only some of which are labeled in FIG. 3 for simplicity.

As illustrated, each of the helix chains 302A, 302B includes multiple emission points 306 distributed along the helix chains 302A, 302B, the emission points 306 acting as spatially distinct emission nodes that define a spatial symbol alphabet and/or non-secret control metadata association. The spacing between emission points 306 may be consistent from one emission point 306 to the next or may be variable. Alternatively or additionally, the density of emission points 306 along any given complete turn of each helix chain 302A, 302B may be, for example, 2, 3, 4, 5, 8, 13, 16, or more or fewer emission points 306 per turn.

The emission points 306 may be associated with classical information as follows. Classical control information and/or spatial symbol labels may be assigned to each emission point 306. At the three-dimensional photonic structure 302, such information may be applied by emitting photons from emission points 306 corresponding to selected spatial symbols and/or non-secret control metadata. At the receiver 304, the emission point 306 (or specifically a spatial coordinate, spatial port index, or spatial symbol associated therewith) of each photon may be detected to recover the associated non-secret control information and/or spatial symbol information for protocol processing.

The specific classical information assigned to the emission points 306 may depend on a given communication protocol. In some embodiments, each emission point 306 may be assigned a unique spatial symbol label. For example, (1) a label 00 may be assigned to emission point 306A, (2) a label 01 may be assigned to emission point 306B, (3) a label 10 may be assigned to emission point 306C, and (4) a label 11 may be assigned to a next emission point 306 following emission point 306C, with potentially other unique labels assigned to the other emission points 306. In some embodiments, the emission points 306 may be assigned redundant labels, such as assigning (1) a label 0 to two or more of the emission points 306 (e.g., 306A and 306C) and (2) a label 1 to two or more others of the emission points 306 (e.g., 306B and the next emission point 306 following 306C), with potentially other redundant labels being assigned to two or more others of the emission points 306.

Quantum information may be encoded in each photon before the photons are provided to the three-dimensional photonic structure 302 and/or within the three-dimensional photonic structure 302. In some embodiments, the quantum information is encoded in the photons using a photon system, such as the photon system 112 of FIGS. 1A and 1D, that includes, for example, a polarization modulator, an OAM modulator, and/or a phase modulator. In some embodiments, for each photon, the OAM state may encode a first set of one or more quantum bits, the polarization state may encode a second set of one or more quantum bits, and the phase state may encode a third set of one or more quantum bits. Thus, a composite quantum state formed from OAM, polarization, and phase may encode more quantum information than any single degree of freedom individually.

Accordingly, in some embodiments, the three-dimensional photonic structure 302 may be utilized to combine spatial symbol association and quantum information into a composite encoding scheme. Each emission point 306 on the three-dimensional photonic structure 302 may be associated with a spatial symbol and/or non-secret control metadata, while the composite quantum state of the photon (e.g., OAM, polarization, and phase) represents the quantum information. The overall composite state (spatial outcome combined with the composite quantum state) may support higher effective information density and protocol flexibility compared to quantum communication methods that rely on a single encoding dimension.

The receiver 304 may include any suitable components to decode the spatial and/or quantum information associated with each photon. For example, the receiver 304 may include one or more components similar to those of the QPU 116 of FIGS. 1A-1B, including the readout subsystem module 128, the spatial data decoder 130 (to detect the emission point 306 of each photon and thereby recover the associated spatial symbol and/or non-secret control metadata), the polarization analyzer 132, the mode sorter 134, and/or the interferometer 136.

The quantum key distribution protocols described below are exemplary and non-limiting implementations of the disclosed dual-layer time-space encoding framework. The invention is not restricted to any particular protocol, basis choice, or reconciliation method unless expressly stated in the claims. The disclosed system may interoperate with QKD protocols such as BB84 or E91 to generate secure encryption keys derived from quantum measurement outcomes.

One or more aspects of these embodiments are not required for practice of all embodiments herein. In more detail, a QKD protocol may be implemented through the system 300 to establish secure cryptographic keys between two parties. The QKD protocol may utilize the unique properties of the 3D photonic structure 302 and the quantum states of photons to ensure the security of the distributed keys.

In one implementation, the system 300 may employ a BB84 protocol adapted for the three-dimensional photonic structure 302. The sender may randomly select emission points 306 along the three-dimensional photonic structure 302 to associate photons with spatial symbols and/or non-secret control metadata, and may encode qubits using one of two mutually unbiased quantum bases. For each bit of the key, the sender may randomly choose between two conjugate bases, such as the rectilinear basis and the diagonal basis for polarization encoding. The spatial selection may add an additional, orthogonal layer of randomness for protocol processing without itself defining secret key bits.

The receiver 304 may independently and randomly choose which basis to measure each received photon, without knowing which basis the sender used to encode it. After the quantum transmission, the sender and receiver may communicate over a classical authenticated channel to compare the bases they used. They may discard all instances where the receiver 304 measured in a different basis than the sender used for encoding. The remaining bits may form the raw key.

The spatial coordinates of the emission points 306 may be used as an additional verification mechanism. The sender may disclose spatial symbol assignments for a subset of transmitted photons over an authenticated classical channel. If an eavesdropper had attempted to intercept the transmission, disturbances in spatial-symbol consistency or correlated quantum measurements may be observed during public verification, indicating a potential intrusion.

The system 300 may implement decoy state QKD to address potential vulnerabilities related to photon number splitting attacks. By randomly varying the intensity of the photon pulses between signal states and decoy states, the legitimate users may detect the presence of an eavesdropper who might be attempting to exploit multi-photon emissions.

Post-processing steps may be applied to the raw key to ensure its security and reliability. Error correction may be performed to reconcile any discrepancies between the sender's and receiver's versions of the key. Privacy amplification techniques may then be applied to reduce any potential information leakage to an eavesdropper to a negligible level.

The 3D photonic structure 302 may enable a high-dimensional QKD protocol by utilizing the OAM states of photons in addition to polarization states. This approach may increase the effective per-photon entropy and support higher-dimensional QKD schemes, thereby allowing more key bits per transmitted photon.

The system may implement continuous-variable QKD (CV-QKD) techniques by encoding information in the quadrature components of the electromagnetic field. This approach may provide resistance to certain types of attacks that target discrete-variable quantum systems, such as intercept-resend or photon-number-splitting attacks.

Authentication mechanisms may be incorporated into the QKD protocol to verify the identity of the communicating parties. Quantum authentication protocols may be combined with classical authentication methods to ensure that only authorized users can access the quantum communication channel.

The system 300 may be integrated with existing cryptographic infrastructure to provide quantum-enhanced security for conventional encryption schemes. The quantum-distributed keys may be used as session keys for symmetric ciphers (e.g., AES-256), key-wrapping, or as entropy seeds in secure key derivation functions.

The system 300 may implement a key management protocol to handle the storage, distribution, and refreshment of quantum-distributed keys. Regular key rotation may be performed to maintain forward secrecy, ensuring that the compromise of one key does not affect the security of past or future communications.

Multiple QKD links based on the 3D photonic structure 302 may be combined to form a quantum key distribution network. Such a network may enable secure communication between multiple parties across extended distances through the use of trusted nodes, quantum repeaters, or entanglement swapping nodes, depending on physical implementation constraints.

The system 300 may incorporate countermeasures against side-channel attacks that target the physical implementation rather than the protocol itself. These countermeasures may include isolation of critical components, randomization of timing patterns, and monitoring of power consumption and electromagnetic emissions.

The system may implement measurement-device-independent QKD (MDI-QKD) to eliminate vulnerabilities in the detection apparatus. In this approach, neither the sender nor the receiver performs the measurements that generate the secure key, thereby removing a significant attack vector from the system. The system 100 and/or 300 and/or distinct instances thereof may be included in the sender and/or the receiver. In such configurations, the sender and receiver may each include an emission module as described herein (e.g., a 3D photonic structure or other structure), and the untrusted relay node may perform Bell-state measurements (BSMs) using interferometers, beam splitters, and coincidence detectors. The measurement results may be publicly broadcast, and the sender and receiver may distill a shared key by post-selecting events based on matching basis choices. The system architecture described herein supports such MDI-QKD implementations through precise emission point control and synchronized photon state modulation. Alternatively or additionally, in MDI-QKD, both sender and receiver may prepare quantum states (often weak coherent pulses) and transmit them to an untrusted third-party measurement node. The untrusted third-party measurement node performs a BSM, and the correlation results are used to distill a key between sender and receiver without either endpoint performing quantum measurements. In some embodiments herein, spatial emission point selection may be used to encode classical control data (e.g., basis selection or time-bin identity), while quantum state modulation aligns with the encoded basis. Embodiments of the emission structure herein (e.g., 3D photonic structure 102, 302) could serve as the physical front-end for such MDI-QKD transmissions enabling controlled, synchronized emission of spatially distinguishable, quantum-encoded pulses toward the untrusted third-party measurement node.

Device-independent QKD (DI-QKD) protocols may be compatible with implementations of the 3D photonic structure 302 in systems that support entangled photon generation and nonlocal measurement. These protocols may provide security guarantees that are independent of the internal workings or trustworthiness of the quantum devices themselves. In such embodiments, the system 300 may be configured to enable entanglement-based transmission between emission points and detectors, and to support statistical verification of Bell inequality violations if entanglement sources and detector isolation permit CHSH (Clauser-Horne-Shimony-Holt) inequality violations under practical constraints. This allows legitimate users to confirm the presence of quantum correlations and detect any eavesdropping or device tampering without relying on assumptions about detector or source behavior.

As an example of one specific QKD protocol, the BB84 protocol may be implemented within the system 300 to provide a robust method for quantum key distribution. The BB84 protocol, named after its creators Charles Bennett and Gilles Brassard in 1984, may utilize quantum properties to establish a secure cryptographic key between two parties, conventionally referred to as Alice and Bob. The protocol may leverage the fundamental principles of quantum mechanics, particularly the no-cloning theorem and the uncertainty principle, to detect any eavesdropping attempts during key exchange.

In the context of the system 300, the BB84 protocol may be implemented as follows. The sender may randomly choose between two conjugate bases for encoding quantum bits. These bases may include the rectilinear basis (horizontal and vertical polarization states, denoted as |0 [symbol] and |1 [symbol] ) and the diagonal basis (45° and 135° polarization states, denoted as |+ [symbol] and |− [symbol] ). The sender may randomly select one of these bases for each photon and then randomly encode either a 0 or 1 by setting the appropriate polarization state within the chosen basis.

The photons may then be emitted from specific emission points 306 along the 3D photonic structure 302, adding a spatial dimension to the quantum key distribution process. The receiver 304 may independently and randomly choose which basis to use for measuring each incoming photon. When the receiver 304 happens to choose the same basis that the sender used for a particular photon, the measurement may yield the correct bit value with high probability. However, when the receiver 304 chooses a different basis than the sender used, the measurement result may be uncorrelated with the bit the sender encoded.

After the quantum transmission phase, the sender and receiver 304 may communicate over a classical channel to compare the bases they used for each photon, without revealing the actual bit values. They may discard all instances where they used different bases, keeping only the bits where they happened to choose the same basis. This process, known as sifting, may result in a shared key that may be approximately half the length of the original sequence.

The security of the BB84 protocol when implemented with the three-dimensional photonic structure 302 may be enhanced by the additional spatial dimension used for spatial symbol association and protocol processing. An eavesdropper attempting to intercept the photons may need to correctly identify both the quantum state and the associated spatial symbol or control metadata, and any measurement disturbance introduced during interception may be detected through increased quantum bit error rates (QBER) or inconsistencies during verification.

To verify the security of the established key, the sender and receiver 304 may perform error estimation by publicly comparing a random subset of their sifted key bits. If the error rate exceeds a predetermined threshold, they may abort the protocol, suspecting eavesdropping. Otherwise, they may proceed with privacy amplification and error correction to derive the final secure key.

The implementation of the BB84 protocol within the system 300 may incorporate the following steps. First, a controller (e.g., the central control module 108 of FIG. 1A) may assign random bases and bit values for each photon to be transmitted using a cryptographically secure pseudorandom generator or entropy source, optionally seeded from a trusted setup phase. Second, a quantum state modulator (e.g., included in the photon system 112 of FIGS. 1A and 1D) may adjust the polarization states of the photons according to the chosen bases and bit values. Third, the controller may select random emission points 306 on the three-dimensional photonic structure 302 to associate photons with spatial symbols and/or non-secret control metadata. Fourth, the photons may be emitted from the selected emission points.

At the receiving end (e.g., the receiver 304), a detector or detector array (e.g., the spatial data decoder 130 of FIG. 1B) may detect the spatial coordinates of the received photons, while the quantum state measurement system (e.g., components 132, 134, and/or 136 of FIG. 1B) may measure the polarization states using randomly chosen bases. The classical communication channel may then be used for basis reconciliation, error estimation, and the subsequent steps of the BB84 protocol. Accurate spatial decoding of emission points is non-trivial and depends on high-resolution photon detectors, time-of-flight calibration, and isolation from ambient noise. Errors in spatial decoding may affect protocol processing (e.g., metadata or symbol association) even when quantum state decoding is successful. Accordingly, the receiver 304 may include spatial filtering optics, timing synchronization systems, and signal discrimination algorithms to ensure reliable recovery of spatial symbol and control information for sifting and reconciliation.

The integration of the BB84 protocol with spatial symbol association provided by the three-dimensional photonic structure 302 may result in a quantum key distribution system with enhanced robustness and protocol flexibility. The multi-dimensional nature of the encoding may support improved key generation efficiency and eavesdropping detectability by leveraging composite quantum and spatial information during sifting and verification.

The three-dimensional photonic structure 302 may offer inherent noise resistance and robustness through its geometric redundancy, in which spatially distributed emission points provide fault tolerance via localized redundancy. In some embodiments, by associating spatial symbols and/or non-secret control metadata with multiple emission points 306, the system 300 may detect and mitigate spatial transmission errors or routing inconsistencies. Alternatively or additionally, classical error correction codes may be applied to non-secret spatial control information and/or post-sifting spatial symbol indices to improve reliability of protocol processing.

In more detail, error correction and noise resistance may be implemented in the system 300 to enhance the reliability and robustness of information transmission. The system 300 may employ one or more layers of error correction mechanisms to address both quantum and classical errors that could arise during transmission.

In some embodiments, particularly those employing intermediate storage nodes, entanglement purification stages, or repeater-like functionality, quantum error detection or correction techniques may be applied to protect stored or processed quantum states. These techniques may include quantum error correction codes such as the Shor code, Steane code, or surface codes, depending on physical implementation constraints and system qubit count, which can detect and correct errors that affect the quantum states of individual photons. The quantum error correction may be implemented by encoding logical qubits across entangled physical qubits, enabling detection and correction of both bit-flip (X) and phase-flip (Z) errors.

For non-secret spatial control information and/or post-sifting spatial symbol indices associated with emission points on the three-dimensional photonic structure 302, conventional error correction codes such as Reed-Solomon, BCH, or LDPC codes may be applied to mitigate spatial detection errors and improve reliability of protocol processing.

The 3D photonic structure 302 itself may contribute to error resistance through its geometric properties. The helical arrangement of emission points may provide spatial diversity, analogous to spatial diversity in MIMO communication systems, allowing recovery from localized transmission disturbances. This spatial redundancy may enhance the resistance of the system 300 to localized disturbances or channel impairments that could affect specific regions of the transmission path.

Noise resistance may be further enhanced through the implementation of noise filtering techniques at both the transmitter and receiver 304 ends of the communication system. At the transmitter (that includes the 3D photonic structure 302), narrow-band filtering (e.g., via Bragg grating filters or etalons) may reduce spectral spread and mitigate chromatic dispersion. At the receiver 304, spatial filtering, spectral filtering, and temporal filtering may be combined to isolate the signal photons from ambient noise and interference.

Adaptive error correction strategies, such as rate-compatible LDPC decoding or dynamic syndrome matrix updates for quantum codes, based on monitored quantum bit error rate (QBER) and environmental conditions, may be employed to optimize the performance of the system 300 under varying channel conditions. The system 300 may continuously monitor the error rates and channel characteristics, adjusting the error correction parameters and encoding schemes to maintain reliable communication even in the presence of time-varying noise and interference.

For QKD applications, decoy-state protocols may help detect photon-number-splitting attacks. These security mechanisms may be complemented by error correction protocols to ensure robust and secure transmission.

The composite nature of the encoding scheme, combining spatial coordinates with multiple quantum states, may provide inherent resistance to certain types of errors and noise. Errors affecting one encoding dimension (e.g., OAM) may not necessarily impact other dimensions (e.g., polarization or spatial coordinates), thereby enabling error localization and partial recovery strategies. For instance, a disturbance affecting phase may still preserve spatial or polarization coherence, enabling fallback decoding.

In some embodiments, the combination of quantum state modulation (e.g., OAM, polarization, phase) and randomization of emission points 306 on the three-dimensional photonic structure 302 may enhance resistance to eavesdropping. Any attempt to intercept or measure the quantum states of the photons results in disturbance detectable through quantum error analysis. Spatial randomization may further complicate an attacker's ability to predict transmission patterns used for protocol processing.

In more detail, security and eavesdropping resistance may be enhanced through multiple mechanisms inherent to the system 300, including quantum measurement disturbance, basis mismatch detection, and consistency checks involving spatial symbols and control metadata during sifting and verification.

The system 300 may implement quantum no-cloning principles to ensure that any attempt to copy or measure the quantum states of photons during transmission disturbs those states in a detectable manner. Since quantum states cannot be perfectly copied according to the quantum no-cloning theorem, any eavesdropping attempt may introduce measurable errors in the received quantum states. Legitimate users may detect such errors by comparing a subset of their transmitted and received measurement outcomes over a classical authenticated channel.

Spatial coordinate randomization may add another layer of security to the communication protocol. By randomly selecting emission points 306 on the three-dimensional photonic structure 302, the system 300 may create an unpredictable transmission pattern that is difficult for an eavesdropper to anticipate or exploit. This spatial randomization may function as an additional obfuscation layer for protocol processing, without itself defining secret key bits.

The system 300 may implement decoy state protocols to further enhance security against potential photon-number-splitting attacks. By randomly varying the intensity of photon pulses between signal states and decoy states, the system 300 may allow legitimate users to estimate the quantum bit error rate and detect the presence of an eavesdropper who might be attempting to exploit multi-photon emissions.

Continuous variable quantum key distribution (CV-QKD) techniques may be optionally supported by modulating quadrature-phase amplitudes of coherent light fields in compatible implementations of the system 300. By encoding information in the quadrature components of the electromagnetic field, the system 300 may create another dimension of security that may be resistant to certain types of attacks that target discrete variable quantum systems.

The system 300 may implement authentication protocols to verify the identity of the communicating parties. Quantum authentication protocols, which may utilize quantum states to verify the identity of the sender and receiver, may be combined with classical authentication methods to ensure that only authorized users can access the quantum communication channel.

Forward secrecy may be maintained by regularly changing emission point assignments and quantum basis selection schemes, which may provide session-level forward secrecy and rotation-resistant keying. This approach may ensure that even if an eavesdropper manages to compromise one session, previous and future sessions may remain secure.

The three-dimensional photonic structure 302 may provide inherent resistance to certain types of physical attacks. The three-dimensional nature of the structure and the precise positioning of emission points 306 may make it difficult for an eavesdropper to physically access or manipulate the quantum channel without detection, particularly when implemented in integrated photonic chips or fiber-coupled architectures with shielding or tamper-detection mechanisms.

Real-time monitoring of quantum bit error rates (QBER) may be implemented to continuously assess the security of the quantum channel. Sudden increases in QBER may indicate the presence of an eavesdropper or channel disturbance, allowing the system to halt transmission or switch to a more secure communication mode.

Post-quantum cryptographic techniques may be incorporated to ensure that the system 300 remains secure even against attacks from future quantum computers. In some embodiments, the system 300 may hybridize QKD with post-quantum encryption algorithms such as lattice-based or code-based schemes to ensure resilience even if classical encryption is compromised in the future

The system 300 may implement privacy amplification techniques to reduce any potential information leakage to an eavesdropper. After detecting errors that might indicate eavesdropping, the legitimate users may apply hash functions to their shared key material, effectively reducing an eavesdropper's knowledge of the final key to a negligible level.

The three-dimensional photonic structure 302 (and/or the three-dimensional photonic structure 102 of FIG. 1A) in some embodiments may be constructed using nanofabrication or three-dimensional printing technology. The three-dimensional photonic structure 302 may have multiple layers of spiral loops. Each loop may represent one complete cycle of the three-dimensional photonic structure 302, containing designated emission points 306 at regular intervals. The three-dimensional photonic structure 302 may be defined by a helix radius, a helix pitch, and emission points 306 on the three-dimensional photonic structure 302. The helix radius is the radial distance from a central axis of the three-dimensional photonic structure 302 and the helix chains 302A, 302B to any emission point on the helix chain 302A, 302B. The helix pitch is the axial distance between corresponding points on successive loops of each of the helix chains 302A, 302B. The emission points 306 are distributed along the helix path, from which photons may be emitted, and each emission point 306 may be uniquely defined by its spatial coordinates.

Although not illustrated in FIG. 3, the system 300 may further include a photon system, such as the photon system 112 of FIGS. 1A and 1D, that includes a quantum photon emitter. The quantum photon emitter, such as the quantum photon emitter 162 of FIG. 1D, may emit photons that each carries a quantum state, including an OAM state (e.g., l=+1, −1, +2, −2, or the like), a polarization state (e.g., horizontal, vertical, left-circular, right-circular, or the like), and a phase state (e.g., 0, π/2, π, 3π/2, or the like). In some embodiments, each polarization state is associated with binary quantum information.

The photon system may further include a quantum state modulator, which may include one or more components to modulate the quantum state of each photon. In some embodiments, the quantum state modulator includes one or more of an OAM modulator (such as the OAM modulator 166 of FIG. 1D), a polarization modulator (such as the polarization modulator 168 of FIG. 1D), and/or a phase modulator (such as the phase modulator 164 of FIG. 1D). The OAM modulator may assign desired OAM states to the photons, e.g., using spatial light modulators (SLMs) or q-plates. The polarization modulator may include a polarization controller that manipulates each photon's polarization state before transmission. For example, the polarization modulator or controller may include a polarization beamsplitter (PBS), and electro-optic modulator (EOM), and/or other suitable polarization controller. The phase modulator may include a phase shifter or other suitable phase modulator to apply phase changes to the photons during their transmission such that each photon includes a desired or modulated phase state after leaving the photon system and/or the 3D photonic structure 302.

Photons having a desired composite state or encoding (e.g., spatial coordinates and composite quantum state) may be transmitted through a quantum channel such as fiber-optic or free-space quantum channels. The composite encoding involves a combination of the spatial coordinates of the emission point 306 and the composite quantum state of each photon (OAM, polarization, phase).

At the receiver 304, a spatial coordinate, spatial port index, or spatial symbol associated with the emission point 306 of each photon may be detected to recover non-secret spatial control information and/or post-sifting spatial symbol information. A spatial detector array may track the origin of each photon based on its emission point 306 along the three-dimensional photonic structure 302 for protocol processing.

The composite quantum state may be measured using any suitable system or device, such as the mode sorter 134, the polarization analyzer 132, and/or the interferometer 136 of FIG. 1B. For example, the mode sorter 134 may include spiral phase plates or holographic plates to measure the OAM state of each photon, which OAM state may then be mapped to the appropriate quantum bit. The polarization analyzer 132 may include one or more PBSs and/or other detectors to measure the polarization state of each photon, which polarization state may then be mapped to the appropriate quantum bit (which may be a binary quantum bit in some embodiments). The interferometer 136 may include a phase-sensitive detector to measure the phase state of each photon and thereby decode the phase-shifted quantum information.

The non-secret spatial information and composite quantum state information of a given photon as detected by the receiver 304 may be combined to generate a protocol data record for processing, including sifting, error estimation, reconciliation, and privacy amplification. In general, each photon's spatial outcome and quantum measurement outcomes may be mapped back to information set during transmission for use in secure key derivation.

FIG. 4 depicts a flowchart 400 of a method for secure quantum communication, arranged in accordance with at least one embodiment described herein. The method 400 may be programmably performed or controlled by a processor in, e.g., a computer and/or server coupled to the classical computing interface 122 of FIG. 1. In an example implementation, the method 400 may be performed in whole or in part by the system 100 of FIG. 1A under the control of a classical processor (coupled to the classical computing interface 122) and/or by the system 300 of FIG. 3 under the control of a classical processor (coupled to a corresponding classical computing interface). Some embodiments herein may include a non-transitory computer-readable storage medium that includes computer-executable instructions executable by a processor device to perform or control performance of any operations herein, such as the operations of the method 400 of FIG. 4. The method 400 may include one or more of blocks 402, 404, 406, and/or 408.

At block 402, the method 400 may include generating a photon. For example, the photon may be generated by the photon system 112, and/or particularly by the photon generation and control system 160 and/or the quantum photon emitter 162 of FIG. 1D. The generated photon may include a composite quantum state that includes two or more of its OAM state, its polarization state, and/or its phase state. Block 402 may be followed by block 404.

At block 404, the method 400 may include modulating OAM state, polarization state, and phase state of the photon to generate a desired composite quantum state of the photon. For example, the various quantum states of the photon may be modulated by the photon system 112, and/or particularly by the OAM modulator 166, the polarization modulator 168, and/or the phase modulator 164 of FIG. 1D. The desired quantum state includes the modulated OAM, polarization, and phase states of the photon. Block 404 may be followed by block 406.

At block 406, the method 400 may include directing the photon to a selected emission point among multiple emission points on a three-dimensional photonic structure. The selected emission point may be associated with a spatial symbol and/or non-secret control metadata used for protocol processing. The selected emission point includes a corresponding spatial coordinate. For example, block 406 may include directing the photon to a selected emission point 306 on the three-dimensional photonic structure 302 of FIG. 3.

At block 408, the method 400 may include emitting the photon from the selected emission point of the three-dimensional photonic structure and into a quantum channel for transmission. The photon may be encoded with the composite quantum state and associated spatial symbol and/or non-secret control metadata for subsequent quantum communication and key distribution processing.

In some embodiments, each emission point of the three-dimensional photonic structure may be associated with a corresponding spatial symbol and/or non-secret control metadata. For example, a first spatial symbol or control label associated with a first emission point may be different than a second spatial symbol or control label associated with a second emission point.

Alternatively or additionally, the method 400 may further include receiving the photon at a receiver, such as the receiver 304 of FIG. 3. The method 400 may further include determining a spatial coordinate, spatial port index, or spatial symbol associated with the emission point as the origin of the photon from the three-dimensional photonic structure. The method 400 may further include measuring the OAM state of the photon, measuring the polarization state of the photon, and measuring the phase state of the photon. The method 400 may further include decoding information associated with the photon based on the spatial outcome and the measured OAM, polarization, and phase states, for protocol processing including sifting and reconciliation.

In some embodiments, the method 400 further includes, prior to receiving the photon at the receiver, encoding redundancy across two or more photons emitted from two or more emission points of the three-dimensional photonic structure, the two or more photons including the photon emitted from the selected emission point. The method 400 may further include, in some embodiments (e.g., where intermediate storage nodes, entanglement purification, or repeater-like functionality are employed), using a quantum error detection or correction code to detect and correct one or more errors at the receiver. The quantum error detection or correction code may include a Shor code, a Steane code, a surface code, or another suitable quantum error detection or correction code.

Alternatively or additionally, the method 400 may further include using a classical error correction code to detect, or to detect and correct, one or more transmission errors in non-secret spatial control information and/or post-sifting spatial symbol indices associated with two or more photons received from the three-dimensional photonic structure at the receiver. The classical error correction code may include a Reed-Solomon code or another suitable classical error correction code.

In some embodiments, the photon is one of two or more photons emitted from two or more of the emission points of the 3D photonic structure. In this and other embodiments, composite quantum states of the two or more photons may be used to generate a secure quantum key for communication between the receiver and a sender that includes the 3D photonic structure. The secure quantum key may be generated from the composite quantum states of the two or more photons according to a QKD protocol. The QKD protocol may include the BB84 protocol or the E91 protocol.

Alternatively or additionally, the method 400 may further include generating multiple photons. The method 400 may further include modulating OAM state, polarization state, and phase state of each of the photons independently. The method 400 may further include randomizing emission points of the 3D photonic structure to which the photons are directed. The method 400 may further include emitting the photons from the randomized emission points and into the quantum channel for transmission. Randomization of emission points may complicate prediction of protocol timing and spatial-symbol patterns used for protocol processing, which may further improve robustness against interception attempts.

FIG. 5 depicts a flowchart 500 of another method for secure quantum communication, arranged in accordance with at least one embodiment described herein. The method 500 may be programmably performed or controlled by a processor in, e.g., a computer and/or server coupled to the classical computing interface 122 of FIG. 1. In an example implementation, the method 500 may be performed in whole or in part by the system 100 of FIG. 1A under the control of a classical processor (coupled to the classical computing interface 122) and/or by the system 300 of FIG. 3 under the control of a classical processor (coupled to a corresponding classical computing interface). Some embodiments herein may include a non-transitory computer-readable storage medium that includes computer-executable instructions executable by a processor device to perform or control performance of any operations herein, such as the operations of the method 500 of FIG. 5. The method 500 may include one or more of blocks 502, 504, 506, 508, and/or 510.

At block 502, the method 500 may include generating a photon. For example, the photon may be generated by the photon system 112, and/or particularly by the photon generation and control system 160 and/or the quantum photon emitter 162 of FIG. 1D. The generated photon may include a composite quantum state that includes two or more of its OAM state, its polarization state, and/or its phase state. Block 502 may be followed by block 504.

At block 504, the method 500 may include encoding information in the photons using a combination of spatial coordinates and composite quantum states of the photons. Block 504 may include one or more of blocks 506, 508, and/or 510.

At block 506, the method 500 may include associating spatial symbols and/or non-secret control metadata with emission points distributed along helix chains of a three-dimensional photonic structure, each emission point having a unique spatial coordinate. Block 506 may be followed by block 508.

At block 508, the method 500 may include modulating composite quantum states of the photons, each composite quantum state including OAM state, polarization state, and phase state of a corresponding photon. Block 508 may be followed by block 510.

At block 510, the method 500 may include emitting the photons with modulated composite quantum states from selected emission points each having associated spatial symbols and/or non-secret control metadata.

In some embodiments, the method 500 may further include implementing quantum error detection and/or error mitigation for quantum states, implementing classical error correction for non-secret spatial control information and/or post-sifting spatial symbol indices, and/or implementing a QKD protocol using the combination of spatial outcomes and quantum-state measurement outcomes.

In some embodiments, time-bin quantum states are prepared using an unbalanced Mach-Zehnder interferometer having a path-length difference corresponding to a selected time-bin duration, spatial encoding is achieved using discrete emission points on a three-dimensional photonic structure, and synchronization between sender and receiver is enforced using time-gated detection windows aligned to the defined time bins.

FIG. 6 illustrates another example quantum computing system 600 (hereinafter “system 600”) that includes a 3D photonic structure 602, arranged in accordance with at least one embodiment herein. The system 600 further includes one or more of a photon source 604, a timing module 606, a modulator 608, a dynamic coupling network 610, and a receiver 612. The receiver 612 may include one or more time-gated detectors 614 and a spatial decoding module 616.

The system 600 of FIG. 6 may extend the architecture of FIGS. 1A-1D from a primarily spatial and internal-state encoding framework to a combined temporal, spatial, and internal-state encoding framework. The 3D photonic structure 602 of FIG. 6 may correspond to, or may include, the 3D photonic structure 102 of FIG. 1A. The 3D photonic structure 602 may, in some embodiments, employ the double-helix configuration of the first helix chain 102A and the second helix chain 102B as described with respect to FIG. 1A. In such embodiments, the emission points along the helix chains 102A, 102B may serve as spatial nodes within the 3D photonic structure 602 while also participating in dual encoding with time bins managed by the timing module 606.

The photon source 604 of FIG. 6 may include, be included in, or correspond to the photon system 112 and/or the photon generation and control system 160 of FIGS. 1A and/or 1D. The photon source 604 may generate photons that may then be modulated in one or more quantum degrees of freedom such as phase, polarization, and OAM. The modulator 608 in FIG. 6 may include, be included in, or correspond to the phase modulator 164, the OAM modulator 166, and/or the polarization modulator 168 of FIG. 1D, and/or to the controller 104, the phase modulator 154, the frequency modulator 156, and/or the amplitude modulator 158 of FIGS. 1A and/or 1C. The modulator 608 may in general prepare and/or implement composite quantum states on photons that may subsequently be injected into the 3D photonic structure 602.

The timing module 606 of FIG. 6 introduces a temporal layer that is not explicitly shown in FIGS. 1A-1D. The timing module 606 may define discrete time bins, frames, and synchronization signals that may align photon emission and detection events relative to a system-wide clock. The timing module 606 may, in some embodiments, be included in or coupled to the central control module 108 and/or the task scheduler 110 of FIG. 1A. In such embodiments, the timing module 606 may coordinate time-bin allocation with the spatial task distribution already described for helix chains 102A, 102B.

The dynamic coupling network 610 of FIG. 6 may provide a hardware-level realization of the waveguides and dynamic couplers 124 of FIG. 1A when extended into a dual time-space domain. The dynamic coupling network 610 may be coupled to or integrated with the 3D photonic structure 602 and may reconfigure optical paths among emission nodes in different time bins. The dynamic coupling network 610 may, in some embodiments, couple temporal slots to spatial lanes so that photons may transition between different helix nodes 102A, 102B, or between different loops or turns within the same helix chain, in a time-dependent manner. The task scheduler 110 and/or the central control module 108 of FIG. 1A may provide control signals that may drive the dynamic coupling network 610 based on computational, communication, or storage objectives.

The receiver 612 of FIG. 6 may include, be included in, or correspond to, e.g., the receiver 304 of FIG. 3 and/or the QPU 116 of FIGS. 1A and 1B. The time-gated detectors 614 in FIG. 6 may extend the detection roles of the sensors 114 in FIG. 1A by enforcing temporal discrimination between time bins. The time-gated detectors 614 may operate under timing references provided by the timing module 606. In parallel, the spatial decoding module 616 of FIG. 6 may perform the same or similar operations as the spatial data decoder 130 of FIG. 1B and/or the spatial detection mechanism of the receiver 304 of FIG. 3. The spatial decoding module 616 may decode the spatial coordinate, such as the index of an emission point on, e.g., helix chains 102A, 102B or other structure(s) within the 3D photonic structure 602, while the time-gated detectors 614 may identify the time bin of arrival.

In some embodiments, the system 600 may be configured so that a photon emitted from a given emission point on the three-dimensional photonic structure 302 of FIG. 3 corresponds to a photon emitted from a corresponding emission node within the three-dimensional photonic structure 602 of FIG. 6. In these and other embodiments, spatial symbol association procedures of FIGS. 3-5 may be reused, and a temporal index may be added by the timing module 606 and enforced at the receiver 612 via the time-gated detectors 614. In such embodiments, a composite mapping may include a time-bin index and a spatial index for protocol processing, while cryptographic key material is derived from matched-basis quantum measurement outcomes.

The system 600 may, in some embodiments, integrate with the error correction module 106 and the entanglement module 126 of FIG. 1A. The error correction module 106 may receive time- and space-resolved measurement data from the receiver 612, which may include detection times from the time-gated detectors 614 and spatial indices from the spatial decoding module 616. This data may be used to perform multidimensional error analysis across temporal, spatial, and quantum-state dimensions. The entanglement module 126 may manage cross-talk and entanglement across time bins and spatial nodes within the 3D photonic structure 602, analogous to the way it may manage entanglement across helix chains 102A, 102B in FIG. 1A.

The timing module 606 of FIG. 6 may coordinate with the task scheduler 110 and the central control module 108 of FIG. 1A to associate specific quantum tasks with designated time bins and spatial nodes. For example, the task 127A in FIG. 1A may be assigned to a subset of time bins and spatial nodes in the 3D photonic structure 602, while the task 127B may be assigned to another subset, with the dynamic coupling network 610 controlling temporal and spatial routing accordingly. The dual encoding framework realized by system 600 may therefore extend the load balancing and parallel processing behavior depicted in FIG. 1A to a time-bin dimension.

The temporal behavior of the system 600 may be described using discrete time bins that may be defined and maintained by the timing module 606. The timing module 606 may generate a master timing reference that may define a frame period T and a time-bin duration Δt. The timing module 606 may partition each frame into multiple non-overlapping time bins. Each time bin may correspond to a distinct temporal coordinate that may be associated with one or more photons within the 3D photonic structure 602.

The timing module 606 may provide clock signals and synchronization markers to the photon source 604, the modulator 608, the dynamic coupling network 610, the receiver 612, and/or an untrusted relay (not illustrated in FIG. 6). The photon source 604 may emit photons in temporal alignment with, e.g., the rising or falling edges of timing pulses received from the timing module 606. The modulator 608 may apply phase, polarization, OAM, and/or amplitude settings that may be scheduled per time bin. The dynamic coupling network 610 may switch optical paths at temporal boundaries between bins. The time-gated detectors 614 may open detection windows that may coincide with the same temporal boundaries.

The timing module 606 may establish a concrete model of temporal synchronization that may include a shared time-bin index across sender and receiver. In one example, the timing module 606 may define a frame with period T that may contain N time bins of equal duration Δt with a guard interval. A transmitter (e.g., the photon source 604, the modulator 608, and/or other elements of FIG. 6) may prepare a photon in |e [symbol] (“early”), |l [symbol] (“late”), or a superposition α|e [symbol] +β|l [symbol] using an unbalanced Mach-Zehnder interferometer (UMZI) and electro-optic phase control. The transmitter may launch the photon so that its arrival falls inside the targeted bin window [kΔt, (k+1)Δt). The receiver 612 may time-gate single-photon detectors to the same windows and, when required, may interfere the time bins using a corresponding unbalanced interferometer to measure in a superposition (conjugate) basis.

An emission clock of the transmitter may be synchronized with a detection/gating clock of the receiver and, when present, BSM gates of an MDI untrusted relay, using a pilot/keep-alive optical tone, frame headers, or out-of-band timing (e.g., White Rabbit or GPSDO). Phase alignment for UMZIs may use pilot pulses and slow feedback.

The entities that may be time-synchronized in system 600 may therefore include, in some embodiments, the photon source 604, the modulator 608, the 3D photonic structure 602, the dynamic coupling network 610, the receiver 612, the time-gated detectors 614, and/or an MDI untrusted relay. The timing module 606 may distribute timing references to each of these entities. The central control module 108 and the task scheduler 110 of FIG. 1A may be synchronized as well so that logical task scheduling may align with the physical time-bin structure. The error correction module 106 and the entanglement module 126 may receive timestamps or bin indices associated with measurement events from the receiver 612 so that error analysis and entanglement tracking may be carried out on a per-bin basis.

The temporal encoding in system 600 may carry multiple types of protocol information depending on configuration. In some embodiments, a time-bin index may be used as non-secret control metadata (e.g., scheduling, framing, or decoy timing), while in other embodiments a photon may be prepared in a quantum superposition of time bins so that time-bin measurement outcomes contribute to sifted key material under matched-basis events. For example, a presence or absence of a photon in a particular bin may encode a binary symbol. Alternatively, a photon that may occupy one of K possible bins within a frame may encode log2(K) bits of classical or logical information. In a quantum framework, a photon may be prepared in a superposition of early and late bins or of multiple bins using an unbalanced interferometric structure coupled to the photon source 604 or the modulator 608. In such an embodiment, the relative phase between probability amplitudes in different bins may encode quantum information that may be accessible via interference at the receiver 612.

In addition to occupancy patterns, the temporal coordinate may carry basis choices or decoy-state identities in QKD applications. For instance, a protocol may assign certain bins within each frame as data-carrying bins and other bins as decoy or monitoring bins. The timing module 606 may provide bin-level flags that may instruct the modulator 608 to adjust intensity, phase randomization, or basis orientation differently in different bins. The receiver 612 may record detection events along with bin indices and may later use these indices during sifting and decoy analysis.

The temporal encoding may further carry control or addressing information for computing and storage embodiments. Time bins may serve as computation cycles in which the dynamic coupling network 610 may realize a particular interferometric pattern across spatial nodes of the 3D photonic structure 602. The same physical spatial network may be reused in successive bins to apply different unitary transformations. In storage embodiments, specific bins may serve as entry or exit windows for delay lines or quantum memory elements that may be coupled to the 3D photonic structure 602. Thus, the bin index may effectively act as an address for write and read operations.

Transitions between time bins may be managed by coordinated updates across, e.g., the timing module 606, the modulator 608, and the dynamic coupling network 610. The timing module 606 may define a temporal boundary between a current bin i and a subsequent bin i+1. Just before the end of bin i, the modulator 608 may complete any phase, polarization, or OAM operations scheduled for that bin. At the boundary, the dynamic coupling network 610 may receive an update to its switching configuration so that spatial paths that may be used in bin i+1 may differ from those used in bin i.

In some embodiments, the dynamic coupling network 610 may contain fast electro-optic couplers that may change state in a time shorter than or comparable to the guard interval between bins. The timing module 606 may designate a small guard time between adjacent bins so that coupler switching may occur without overlapping active intervals. The guard time may reduce temporal cross-talk between bins. The time-gated detectors 614 may open windows that may exclude the guard intervals so that only photons that arrive within the stable central portion of each bin may be registered.

A more concrete model of time-bin transition may be described as follows. At the beginning of bin i, the photon source 604 may emit a pulse that may be injected into the 3D photonic structure 602 through a selected port of the dynamic coupling network 610. The modulator 608 may have set the internal-state parameters for that bin, and the dynamic coupling network 610 may have configured a particular path through spatial nodes of the 3D photonic structure 602. During bin i, the photon may propagate along that path and may undergo interactions or interferometric combinations defined for that bin. As bin i approaches its end, the photon may either reach an output port that may couple to the quantum channel or may be directed into a storage element that may delay it into a later bin.

If the photon is routed into a delay line that may have a propagation time equal to one or more bin durations, the photon may re-enter the 3D photonic structure 602 at a later bin j. The timing module 606 may take into account these delay-line lengths when assigning emission and retrieval bins, so that the photon's arrival coincides with the appropriate bin boundary. In this way, transitions between bins may not only correspond to local updates in modulator settings but may also represent physical time shifts of photons through delay structures that may be coordinated by the dynamic coupling network 610.

In QKD embodiments based on time-bin encoding, the timing module 606 may schedule early and late bins within a frame as distinct logical levels. The modulator 608 may prepare the photon in |early [symbol] , |late [symbol] , or a superposition α|early [symbol] +β|late [symbol] by using an unbalanced interferometer in which one arm may delay the photon by Δt relative to the other. The receiver 612 may measure in the computational basis by time-resolved detection in the time-gated detectors 614 or may measure in a superposition basis by inserting a corresponding unbalanced interferometer before the detectors and applying appropriate phase settings. Temporal synchronization may ensure that early and late peaks at the receiver may align with expected detection windows.

The temporal encoding may further carry entanglement information. In some embodiments, the photon source 604 or a coupled entangled-photon source may generate entangled time-bin pairs that may be injected into different spatial nodes of the 3D photonic structure 602. The entanglement module 126 may maintain a record of which bin pairs are entangled and may coordinate measurement settings of the receiver 612 accordingly. The time-gated detectors 614 may detect coincidence events that may be labeled with time-bin indices, allowing Bell-type correlation analysis across time-bin indices and spatial node indices.

Accordingly, temporal encoding may carry quantum information or classical information, depending on basis. For example, quantum information may be implemented with time-bin qubits |e [symbol] , |l [symbol] , α|e [symbol] +β|l [symbol] and phase between them. Classical information may be implemented using the bin index to carry metadata (frame counters, decoy flags, spatial index parity) while measuring only arrival time (no interference). Quantum time-bins may be used for QKD key bits and classical indices may be used for protocol control.

Some embodiments described in this section illustrate optional extensions and applications of the dual-layer encoding framework. One or more aspects of these embodiments are not required for practice of all embodiments herein. In computing embodiments, the timing module 606 may allow the task scheduler 110 to define bin-level compute cycles. Each bin may correspond to a stage in a quantum optical circuit applied across spatial nodes of the 3D photonic structure 602. The dynamic coupling network 610 may update its configuration between bins so that different unitary transformations may be applied sequentially in time while reusing the same physical hardware. The time-gated detectors 614 may measure outputs at selected bins to provide intermediate results. The central control module 108 may use these time-stamped results to adjust coupler settings for subsequent bins, enabling feed-forward logic.

In storage embodiments, temporal encoding may define memory cells. A photon that may occupy bin i when written into a storage loop may re-emerge in bin i+m after m cycles. The timing module 606 may assign logical memory addresses that may be mapped to particular (bin, spatial node) pairs. The dynamic coupling network 610 may manage insertion and extraction of photons from loops or resonators so that each memory operation may occur in a preassigned bin. Time-gated detectors 614 may verify successful write and read operations by detecting presence or absence of photons in the corresponding bins.

The temporal synchronization across these entities may provide a coherent framework in which the dual encoding in time and space may operate. The time-bin structure created by the timing module 606 may provide an additional orthogonal dimension of encoding that may work together with the spatial emission coordinates of the 3D photonic structure 602 and the internal-state modulation performed by the modulator 608. The composite encoding in time, space, and quantum state may allow the system 600 to carry dense classical information, high-dimensional quantum information, and protocol control data within the same set of photons while maintaining temporal alignment between emission, propagation, coupling, and detection events.

Spatial encoding in the system 600 may utilize the discrete physical coordinates of emission points within the 3D photonic structure 602 to carry information. Each emission point may be assigned a unique spatial coordinate that may be expressed in a three-dimensional coordinate system. The spatial coordinate may serve as an independent encoding dimension that may operate in parallel with temporal encoding provided by time bins and with quantum state encoding provided by modulation of polarization, OAM, and phase for spatial symbol association and/or spatial-mode quantum encoding, depending on embodiment.

The 3D photonic structure 602 may include multiple emission points distributed across a defined geometric arrangement, such as first and second helix chains 102A, 102B described with respect to FIG. 1A. In other embodiments, the geometric arrangement may include linear chains, planar grids, radial layouts, circular loops, spiral arms, or arbitrary two-dimensional or three-dimensional arrays. Each emission point may be uniquely identifiable by its spatial coordinate within the chosen geometric arrangement.

A spatial encoding subsystem may include hardware elements that may route photons to selected emission points based on a spatial index or spatial coordinate assignment and may include, e.g., the dynamic coupling network 610 and/or other elements. The dynamic coupling network 610 may include optical switches, waveguide arrays, or free-space beam steering elements that may direct photons from a common source or modulator to one of multiple output ports corresponding to distinct emission points. The optical switches may be electro-optic switches that may change state in response to control signals from a controller (e.g., the control module 108). The waveguide arrays may be integrated photonic circuits that may couple light from a single input waveguide to one of multiple output waveguides based on the configuration of intermediate couplers or switches. The free-space beam steering elements may include MEMS mirrors, spatial light modulators, or other devices that may adjust the propagation direction of a photon so that it may reach a selected emission point.

In embodiments described herein, spatial coordinates primarily serve for spatial symbol association and/or non-secret control metadata. In embodiments employing spatial-mode quantum encoding, quantum information may be encoded in a spatial-mode basis via coherent superposition across multiple spatial paths. Spatial coordinates are not required to define secret key bits unless expressly stated in the claims. The spatial coordinate of each emission point may be used for spatial symbol association and/or non-secret control metadata (e.g., addressing, routing, timing tags, decoy indicators, or basis tags) in some embodiments. In other embodiments, or in addition, a photon may encode quantum information in a spatial-mode basis via coherent superposition across multiple spatial paths associated with different emission points, such that the spatial degree of freedom functions as a quantum encoding dimension.

In embodiments where spatial coordinates are used for non-secret control metadata or spatial symbol labeling, each spatial coordinate (or an index associated therewith) may be mapped to a non-secret label or symbol (e.g., a frame marker, a routing identifier, a time-slot tag, a decoy flag, or a basis tag). In some implementations, multiple emission points may share a redundant label for robustness, calibration, traffic shaping, or decoy scheduling.

In embodiments where spatial modes encode quantum information, the spatial degree of freedom may represent a basis state in a high-dimensional quantum system (e.g., a spatial qudit). For example, a photon routed to a first spatial mode associated with a first emission point may represent a first spatial basis state, and a photon routed to a second spatial mode associated with a second emission point may represent a second spatial basis state. A photon emitted from a first spatial coordinate may represent a first basis state, and a photon emitted from a second spatial coordinate may represent a second basis state. A photon prepared in a coherent superposition of two or more spatial paths may represent a superposition of basis states in the spatial degree of freedom. Such superposition may be created by routing the photon through a beam splitter or directional coupler that may coherently split the photon's amplitude among multiple spatial paths leading to different emission points.

The spatial encoding may be combined with temporal encoding and quantum state encoding to form a composite encoding scheme. In the composite encoding scheme, each photon may carry information encoded in three independent dimensions: a temporal coordinate corresponding to a time bin, a spatial coordinate corresponding to an emission point, and a quantum state coordinate corresponding to polarization, OAM, phase, or a combination thereof. The composite state of a photon may be represented as a tensor product of states in each dimension, or as a joint probability distribution over temporal, spatial, and quantum state indices, or in some other form.

The spatial encoding may support randomization of emission points to enhance security in quantum communication applications. In QKD embodiments, the spatial coordinate of each photon may be selected randomly or pseudorandomly from a set of available emission points. The random selection may add an additional layer of entropy that may make it more difficult for an eavesdropper to predict or intercept the transmitted photons. The receiver 612 may be equipped with a spatial decoding module 616 that may detect the spatial coordinate of each received photon. The random selection may add an additional layer of entropy that may make it more difficult for an eavesdropper to predict or intercept the transmitted photons. The receiver 612 may be equipped with a spatial decoding module 616 that may detect the spatial coordinate or spatial port index of each received photon for spatial symbol association and protocol processing.

In some embodiments, the spatial decoding module 616 may map detected spatial coordinates (or spatial port indices) to non-secret control metadata and/or post-sifting spatial symbol indices according to a predefined or dynamically updated mapping. The mapping may be shared between the sender and the receiver 612 through a classical authenticated channel or through a pre-shared key. The spatial decoding module 616 may output a spatial index for each detected photon, which may be combined with the temporal index provided by the time-gated detectors 614 and with quantum measurement results to form protocol records for sifting, reconciliation, and key derivation.

The spatial encoding may be used to implement spatial redundancy for error correction or for quantum information storage. The spatial redundancy may be combined with quantum error detection and/or correction mechanisms in embodiments employing intermediate storage nodes, purification stages, or repeater-like functionality, to detect and correct errors that may affect any of these dimensions. In embodiments where spatial redundancy is employed, the same information may be encoded in photons emitted from multiple spatially distinct emission points. If one emission point or one spatial path experiences loss or noise, the information may still be recovered from the other emission points. The spatial redundancy may be combined with quantum error correction codes that may operate across the spatial dimension, temporal dimension, and quantum state dimension to detect and correct errors that may affect any of these dimensions.

FIG. 7 depicts a flowchart 700 of a method for dual-layer quantum communication and computation, arranged in accordance with at least one embodiment described herein. The method 700 may be programmably performed or controlled by a processor in, e.g., a computer and/or server coupled to the classical computing interface 122 of FIG. 1. In an example implementation, the method 700 may be performed in whole or in part by the system 100 of FIG. 1A under the control of a classical processor (coupled to the classical computing interface 122), by the system 300 of FIG. 3 under the control of a classical processor (coupled to a corresponding classical computing interface), and/or by the system 600 of FIG. 6 under the control of a classical processor (coupled to a corresponding classical computing interface). Some embodiments herein may include a non-transitory computer-readable storage medium that includes computer-executable instructions executable by a processor device to perform or control performance of any operations herein, such as the operations of the method 700 of FIG. 7. The method 700 may include one or more of blocks 702, 704, 706, 708, 710, and/or 712.

At block 702, the method 700 may include generating a photon. The photon may be generated by the photon source 604 of FIG. 6. The photon source 604 may include a pulsed laser, a continuous-wave laser with intensity modulation, or a heralded single-photon source. The photon source 604 may emit photons at wavelengths suitable for propagation through optical fiber or free-space channels. In some embodiments, the photon source 604 may generate weak coherent pulses for use in QKD protocols. The photon may be generated with properties that may allow subsequent modulation of its quantum state.

At block 704, the method 700 may include establishing a time-bin frame having a period T and multiple non-overlapping time bins of duration Δt. The timing module 606 of FIG. 6 may establish the time-bin frame. The timing module 606 may define a master timing reference that may partition each frame into discrete temporal slots. Each time bin may correspond to a distinct temporal coordinate within the frame. The time bins may be separated by guard intervals to reduce temporal cross-talk between adjacent bins. The timing module 606 may generate synchronization signals that may coordinate emission and detection events across the system 600. In some embodiments, establishing the time-bin at block 704 frame includes transmitting pilot optical pulses or classical sync symbols to align clocks of a sender and a receiver. In this and other embodiments, the receiver may admit detections only within gated windows of width Δt centered on expected bin arrivals.

At block 706, the method 700 may include preparing a quantum state of the photon in a time-bin basis and in at least one additional quantum degree of freedom to form a composite quantum state. The additional quantum degree of freedom may be selected from polarization, OAM, and phase. The modulator 608 of FIG. 6 may prepare the quantum state of the photon. The modulator 608 may include an unbalanced Mach-Zehnder interferometer (UMZI) to create superpositions of early and late time bins. The modulator 608 may further alternatively or additionally include electro-optic phase modulators, polarization controllers, and/or OAM generation elements. The preparation of the quantum state may result in a composite quantum state that may encode information in multiple independent dimensions. The time-bin basis may encode a first set of quantum information. The additional quantum degree of freedom may encode a second set of quantum information. The composite quantum state may thereby carry more information per photon than encoding in a single degree of freedom alone.

At block 708, the method 700 may include routing a photon to a selected emission point of a 3D photonic structure having multiple emission points with respective spatial coordinates. The 3D photonic structure may be the 3D photonic structure 602 of FIG. 6, the 3D photonic structure 302 of FIG. 3, and/or the 3D photonic structure 102 of FIG. 1A. the 3D photonic structure may include a double-helix or lattice arrangement, and each emission point may correspond to a distinct spatial-mode (path-mode) basis state associated with a unique spatial coordinate. The dynamic coupling network 610 of FIG. 6 may route the photon to the selected emission point. The dynamic coupling network 610 may include optical switches, waveguide arrays, beam steering elements, and/or other elements to dynamically route photons to desired emission points on the 3D photonic structure 602. The selection of the emission point may be based on a spatial symbol association and/or non-secret control metadata scheme, and in some embodiments may additionally support spatial-mode quantum encoding via coherent superposition across spatial paths. The routing operation may preserve coherence of the photon's composite quantum state.

At block 710, the method 700 may include synchronizing a sender and a receiver with a shared timing reference and time-gated detection windows aligned to the time bins. The sender may include components of the system 600 that may generate and emit photons, such as the photon source 604, the modulator 608, and the 3D photonic structure 602. The receiver may be the receiver 612 of FIG. 6. The timing module 606 may provide the shared timing reference to both the sender and the receiver 612. The shared timing reference may ensure that time-gated detection windows at the receiver 612 are aligned to the time bins defined by the timing module 606. The synchronization may enable the receiver 612 to detect photons in the correct temporal slots. The time-gated detectors 614 of FIG. 6 may open detection windows that may coincide with the temporal boundaries of the time bins. The synchronization may reduce detection errors that may arise from temporal misalignment between emission and detection events.

At block 712, the method 700 may include emitting the photon from the selected emission point into a quantum channel. The quantum channel may be an optical fiber, a free-space optical link, or another suitable transmission medium. The emission may occur during a time bin that may correspond to the temporal coordinate assigned to the photon. The photon may carry the composite quantum state prepared at block 706. The photon may carry the composite quantum state prepared at block 706 and may be associated with a spatial outcome (e.g., spatial port index or spatial symbol) used for protocol processing. In embodiments employing spatial-mode quantum encoding, the photon may additionally carry quantum information in a spatial-mode basis.

The method 700 may thereby encode information in a photon using a combination of temporal encoding, spatial encoding, and quantum state encoding. The temporal encoding may be provided by the time-bin structure established at block 704 and by the time-bin basis preparation at block 706. The spatial encoding may be provided by the routing to a selected emission point at block 708 and emission from the selected emission point at block 712. The quantum state encoding may be provided by the modulation of additional quantum degrees of freedom at block 706. The composite encoding may result in a high-dimensional information space that may support increased information density, enhanced security, and improved robustness compared to encoding in a single dimension.

In some embodiments, the method 700 further includes transitioning the photon between time bins by applying a variable optical delay equal to an integer multiple of Δt under control of a dynamic coupling module. The dynamic coupling module may include, be included in, or correspond to the dynamic coupling network 610 of FIG. 6. The dynamic coupling module may include an optical switch network and a phase or electro-optic modulator configured to preserve quantum coherence while altering one or both of an arrival time of the photon or a spatial path of the photon.

In some embodiments, the method 700 further includes randomizing emission-point selection across the 3D photonic structure according to a pseudorandom sequence to introduce spatial entropy for key distribution.

In some embodiments, the combination of the time-bin state and emission-point coordinate forms a composite codeword. In this and other embodiments, the method 700 may further include decoding the composite codeword at a receiver (e.g., the receiver 612) by: (i) determining a spatial coordinate, spatial port index, or spatial symbol associated with the emission point to recover non-secret control metadata and/or post-sifting spatial symbol information; and (ii) measuring the quantum state in at least one of the time-bin, polarization, OAM, or phase bases to recover quantum measurement outcomes used for sifting and key derivation.

In some embodiments, the dual-layer encoding of the method 700 of FIG. 7 is used for QKD, with cryptographic key material derived from matched-basis quantum measurement outcomes associated with at least one of time-bin states and additional quantum degrees of freedom, and sifting performed based on compatible basis selections. In some embodiments, an untrusted relay node is configured to perform Bell-state measurements (BSMs) on photons received from the sender (Alice) and the receiver (Bob). Successful BSM events may establish correlations used for key generation without trusting measurement devices at the relay. Spatial emission-point selection may be randomized independently of quantum basis choices and used for protocol scheduling and verification.

Accordingly, the method 700 may be applied to QKD applications. In QKD embodiments, the time-bin basis at block 706 may be selected randomly or pseudorandomly from a set of mutually unbiased bases. The spatial coordinate at block 708 may be selected randomly or pseudorandomly from the multiple emission points of the 3D photonic structure 602. The random selection of time-bin basis and emission-point selection may add independent sources of randomness for protocol processing and may complicate interception attempts. The composite encoding may thereby increase detectability of eavesdropping attempts through QBER analysis and consistency checks. An eavesdropper attempting to intercept the photon may face increased difficulty in predicting both the temporal and spatial encoding parameters. The composite encoding may thereby increase the detectability of eavesdropping attempts.

The method 700 may be applied to MDI-QKD protocols. In MDI-QKD embodiments, two senders may each perform the method 700 to generate and emit photons toward an untrusted relay. The untrusted relay may perform BSMs on photons received from the two senders. The untrusted relay may publicly announce successful BSM events and their outcomes. The two senders may use the announcements to derive correlated raw keys without performing key-generating measurements at their own locations. The dual encoding in time and space may be employed at the sender locations to schedule time-bin emissions, to randomize spatial emission indices, and to modulate quantum states. The untrusted relay may perform standard two-photon interference and coincidence detection without requiring knowledge of the spatial encoding employed by the senders.

The method 700 may be applied to continuous-variable QKD (CV-QKD) protocols. In CV-QKD embodiments, the photon source 604 may generate coherent states with Gaussian-modulated quadrature amplitudes. The modulator 608 may modulate the in-phase and quadrature components of the coherent states. The time-bin frame at block 704 may define temporal slots for transmission of the modulated coherent states. The spatial coordinate at block 708 may be used to randomize emission points for decoy states or pilot tones. The receiver 612 may perform homodyne or heterodyne detection with phase tracking to measure the quadrature components. The dual encoding may integrate temporal scheduling and spatial randomization into the CV-QKD protocol to enhance security and channel efficiency for protocol control and monitoring (e.g., decoy or pilot scheduling), without requiring the spatial coordinate itself to define secret key bits.

The method 700 may be applied to quantum computing applications. In quantum computing embodiments, the time bins may represent computation cycles. The spatial coordinates may represent logical qubits or optical modes. The dynamic coupling network 610 may reconfigure optical paths among emission points in different time bins to realize sequential unitary transformations. The method 700 may thereby enable parallel quantum operations distributed across both time and space. The time-gated detectors 614 may measure outputs at selected time bins to provide intermediate computational results. The receiver 612 may forward the results to a classical controller that may adjust coupler settings for subsequent time bins to implement feed-forward logic.

The method 700 may be applied to quantum information storage applications. In storage embodiments, the time bins may serve as memory cells. A photon may be written into a storage element, such as a delay line or quantum memory, at a designated time bin. The storage element may hold the photon for a specified number of time bins. The photon may be retrieved from the storage element at a later time bin. The spatial coordinates may provide redundancy by distributing replicas of the photon across multiple spatially distinct storage elements. The method 700 may thereby enable robust quantum information storage with temporal addressing and spatial redundancy.

The method 700 may further include updating the dynamic coupling network 610 between time bins. The dynamic coupling network 610 may change its switching configuration at temporal boundaries between adjacent time bins. The timing module 606 may designate guard intervals between time bins during which coupler switching may occur. The guard intervals may reduce temporal cross-talk by ensuring that coupler transitions do not overlap with active photon propagation intervals. The dynamic coupling network 610 may thereby support coherent routing of photons among different spatial paths in different time bins while preserving quantum coherence.

The method 700 may further include applying error detection and mitigation across temporal, spatial, and quantum-state dimensions. The receiver 612 may detect deviations affecting the temporal index, the spatial index, or quantum measurement outcomes. In some embodiments (e.g., those employing intermediate storage nodes, entanglement purification stages, or repeater-like functionality), quantum error detection and/or correction mechanisms may be applied to stored or processed quantum states distributed across multiple photons. Additionally, classical error correction codes may be applied to non-secret spatial control information and/or post-sifting spatial symbol indices used for protocol processing.

The method 700 may further include randomizing emission points among positions on the 3D photonic structure 602. The randomization may introduce spatial entropy that may enhance security in QKD applications. The randomization may be performed by the dynamic coupling network 610 under control of a random number generator. The receiver 612 may use protocol records (including spatial symbol outputs and authenticated control metadata) to associate detection events with expected scheduling and to support sifting and reconciliation. An eavesdropper lacking knowledge of the control schedule may be unable to predict the spatial emission pattern used for protocol processing, thereby complicating interception attempts.

The method 700 may further include encoding multiple components of information per photon using temporal coordinates, spatial outcomes, and quantum-state properties. The temporal coordinate may encode a first component of information based on a time-bin index or time-bin superposition. The spatial coordinate may be used to associate a spatial symbol and/or non-secret control metadata (e.g., routing, scheduling, decoy flags, or addressing) and, in embodiments employing spatial-mode quantum encoding, may additionally support quantum information in a spatial-mode basis via coherent superposition across spatial paths. The quantum-state properties may encode quantum information based on polarization, OAM, phase, or a combination thereof.

The method 700 may further include generating a secure quantum key from two or more photons emitted from emission points of the 3D photonic structure 602. The secure quantum key may be generated according to a QKD protocol such as the BB84 protocol or the E91 protocol. The QKD protocol may utilize the composite quantum states and spatial coordinates of the photons to establish a shared secret key between the sender and the receiver 612. The QKD protocol may utilize composite quantum measurement outcomes together with associated temporal and spatial protocol records to establish a shared secret key between the sender and the receiver 612.

The method 700 may further include performing basis reconciliation between the sender and the receiver 612. The basis reconciliation may involve the sender and the receiver 612 exchanging information over a classical authenticated channel to identify photons for which they used compatible measurement bases. The basis reconciliation may further account for time-bin basis choices and the bases used for measuring additional quantum degrees of freedom, as well as spatial symbols and/or non-secret control metadata used for protocol processing. Photons for which the sender and the receiver 612 used compatible bases may be retained for key generation, and other photons may be discarded.

The method 700 may further include performing decoy-state analysis to detect potential eavesdropping. The decoy-state analysis may involve the sender randomly varying the intensity of photon pulses among signal states, decoy states, and vacuum states. The receiver 612 may detect the photons and record their detection statistics. The sender and the receiver 612 may compare the detection statistics to expected values to estimate the quantum bit error rate and to detect the presence of an eavesdropper. The dual encoding may support decoy-state analysis by allowing the sender to assign different intensities to photons emitted from different spatial coordinates or in different time bins.

The method 700 may further include applying privacy amplification to the raw key material. The privacy amplification may reduce any potential information leakage to an eavesdropper to a negligible level. The privacy amplification may involve applying a hash function to the raw key to produce a shorter final key. The hash function may be chosen such that an eavesdropper's knowledge of the final key may be negligible even if the eavesdropper possessed partial information about the raw key. The dual encoding may enhance the effectiveness of privacy amplification by providing multiple independent sources of entropy that may reduce the eavesdropper's information.

The method 700 may be implemented in a system that may include a sender apparatus and a receiver apparatus. The sender apparatus may include the photon source 604, the modulator 608, the 3D photonic structure 602, and the dynamic coupling network 610. The receiver apparatus may include the receiver 612, the time-gated detectors 614, and the spatial decoding module 616. The sender apparatus and the receiver apparatus may be connected by a quantum channel. The sender apparatus and the receiver apparatus may further be connected by a classical authenticated channel for exchanging synchronization information, basis reconciliation data, and other classical information.

The temporal-spatial dual encoding described herein may have a number of applications, including QKD with enhanced security through composite encoding. Two specific examples of QKD include MDI-QKD and CV-QKD. MDI-QKD provides a quantum communication protocol that may eliminate security vulnerabilities associated with detection apparatus. In conventional QKD implementations, the receiver may perform measurements on quantum states to extract key information. These measurements may introduce potential attack vectors, as an eavesdropper may exploit imperfections in the detection hardware. MDI-QKD may address this vulnerability by removing the requirement for trusted measurement devices at either communication endpoint.

In MDI-QKD implementations, two legitimate parties, conventionally referred to as Alice and Bob, may prepare quantum states and transmit them to an untrusted relay node, often designated as Charlie. Neither Alice nor Bob may perform measurements that directly generate key material. Instead, Charlie may perform BSMs on the received quantum states. The measurement results may be publicly announced by Charlie over a classical channel. Alice and Bob may use these publicly announced results, combined with their local preparation records, to establish correlated raw keys through a process known as sifting.

The security of MDI-QKD may rely on the fundamental principles of quantum mechanics rather than on the trustworthiness or perfection of the measurement apparatus. An eavesdropper may gain no advantage by compromising Charlie's measurement devices, as Charlie may possess no information about the individual preparation choices made by Alice and Bob. The protocol may detect any attempt to intercept or manipulate the quantum states during transmission through statistical analysis of the correlations between Alice's and Bob's preparation records and Charlie's measurement outcomes. In embodiments herein, each endpoint may have a configuration such as described in, e.g., FIGS. 1, 3, and/or 6 and may use its 3D photonic structure to schedule time-bins, select emission points for spatial entropy/decoying, and modulate quantum states (e.g., phase in a UMZI). The untrusted relay node, Charlie, performs standard BSM and does not need, but can optionally include, a 3D photonic structure such as described in FIGS. 1, 3, and/or 6.

CV-QKD may encode quantum information in the quadrature components of electromagnetic field states rather than in discrete photon number states. The quadrature components may represent the amplitude and phase of a coherent optical field. CV-QKD protocols may employ Gaussian-modulated coherent states, in which the quadrature values may be drawn from continuous Gaussian probability distributions. The sender may prepare coherent states with randomly modulated quadrature amplitudes and transmit these states through a quantum channel to the receiver.

The receiver in a CV-QKD system may perform homodyne detection or heterodyne detection to measure the quadrature components of the received optical field. Homodyne detection may measure a single quadrature by interfering the signal with a strong local oscillator. Heterodyne detection may measure both quadratures simultaneously by using a balanced detection scheme. The measurement outcomes may be continuous variables rather than discrete detection events. The sender and receiver may subsequently perform classical post-processing operations, including parameter estimation, reconciliation, and privacy amplification, to distill a secure key from the correlated continuous-variable measurements. In embodiments herein, each endpoint may have a configuration such as described in, e.g., FIGS. 1, 3, and/or 6 and may use its 3D photonic structure to schedule time-bins, randomize spatial emission points for decoying, and integrate electro-optic phase/amplitude modulators on-chip.

Practical implementations of high-dimensional QKD may employ temporal bins and spatial positions to encode high-dimensional quantum states. Randomization of temporal and spatial encodings may enhance security against eavesdropping. In more detail, and referring to FIG. 6, the timing module 606 defines a frame Tf and time bin Δt. The photon source 604 may emit phase-randomized weak coherent pulses (WCPs). The modulator 608, which may include a UMZI and phase modulator, may prepare each pulse in |e [symbol] , |l [symbol] , or α|e [symbol] +β|l [symbol] . A spatial selector, e.g., as part of the dynamic coupling network 610, may route the pulse to a selected emission point (per pseudorandom schedule). A transmitter, e.g., as the 3D photonic structure 602, may launch the pulse from the selected emission point into a quantum channel at a target time bin defined by the timing module 606 to the receiver 612. The receiver 612 time-gates detectors 614 (e.g., avalanche photodiodes (APDs) and/or single avalanche photodiode (SPADs)), measures in time or superposition basis (UMZI), and records the spatial index. A classical channel performs basis reconciliation, decoy analysis, and error estimation. If MDI-QKD is being implemented, an untrusted relay (not illustrated in FIG. 6) performs BSM and broadcasts successes. Finally, post-processing executes error correction and privacy amplification to produce a key. According to some embodiments, independent randomization of time-bin basis selection and spatial emission-point selection may increase the detectability of eavesdropping through error-rate analysis and consistency checks during sifting and verification. Alternatively or additionally, spatial randomization may complicate detector-side and channel-manipulation attacks without requiring the spatial coordinate itself to define secret key bits.

Practical implementations of parallel quantum computing may employ temporal bins to represent computation cycles and spatial positions may encode logical qubits, enabling parallel quantum operations. In more detail, a scheduler may map logical qubits or optical modes to emission points (spatial lanes) on the 3D photonic structure 602. Clocking may use time bins as pipeline cycles for linear-optical operations (e.g., programmable Mach-Zehnder interferometer (MZI) meshes for unitary mixing) between lanes. One or more electro-optic (EO) switches (e.g., in the dynamic coupling network 610) may couple adjacent nodes (same or cross-helix) during specific time bins to realize interferometers. Detectors (e.g., the time-gated detectors 614) may capture outcomes per bin. Feedforward updates may switch phases for subsequent bins. Accordingly, the system 600 of FIG. 6 may execute multiple interferometric operations in parallel across spatial lanes and over time, increasing throughput.

In these and other embodiments, the architecture for parallel quantum computing may include a network of dynamically reconfigurable couplers that may route quantum carriers among spatial channels and temporal slots. These couplers may be implemented using EO switches, Mach-Zehnder interferometers, and/or directional couplers with tunable splitting ratios. A control module may coordinate the coupler configurations across time, defining which spatial channels may be coupled during each temporal cycle. The control module may receive feedback from measurement outcomes and may adjust subsequent coupler settings to implement feed-forward operations. This dynamic reconfiguration may allow the same physical resources to be repurposed across different stages of a quantum algorithm, increasing the effective computational capacity without proportionally increasing the physical hardware footprint.

Quantum information storage may preserve quantum states for extended durations, enabling buffering, synchronization, or long-term retention of quantum data. Storage mechanisms may include optical delay lines, resonant cavities, quantum memories based on atomic or solid-state media, or other systems capable of maintaining quantum coherence over time. The storage duration may range from nanoseconds to seconds or longer, depending on the physical implementation and the coherence properties of the storage medium.

Practical implementations of quantum information storage may employ temporal bins as memory cells and spatial redundancy may ensure robust data recovery. In more detail, a write path may route an encoded pulse into a fiber/spiral delay matched to nΔt. Circulation may hold the pulse for n frames using low-loss loops and periodic refresh. A read path may release the pulse into a target bin on demand. Spatial redundancy may write replicas into distinct helix points/loops of the 3D photonic structure 602 for erasure recovery. In some embodiments, for true quantum storage, a compatible quantum memory (e.g., AFC in rare-earth doped media) may be substituted for the 3D photonic structure 602. For classical buffering, fiber delays suffice.

Optical delay lines may provide a simple approach to quantum information storage by routing photons through extended optical paths. A delay line may consist of a fiber-optic cable, an integrated waveguide spiral, or a free-space optical path with mirrors. The propagation time through the delay line may determine the storage duration. By selecting delay lines with propagation times equal to integer multiples of a fundamental time-bin duration, the system may align stored photons with designated temporal slots upon retrieval. Optical switches may control insertion and extraction of photons into and out of the delay lines, enabling dynamic read and write operations.

Quantum memories based on atomic ensembles or rare-earth-doped crystals may offer longer storage times and active control over the storage process. These memories may absorb incoming photons and map their quantum states onto collective excitations of the storage medium. The stored excitations may be retrieved on demand by applying control fields that reverse the storage process. Quantum memories may provide capabilities beyond simple delay, including wavelength conversion, temporal mode reshaping, and entanglement preservation. Spatial redundancy may be implemented by replicating stored quantum states across multiple spatially distinct storage elements. If one storage path experiences loss or decoherence, the quantum information may be recovered from redundant copies stored at other spatial locations.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

The subject technology of the present disclosure is illustrated, for example, according to various aspects described below. Various examples of aspects of the present disclosure are described as numbered examples (1, 2, 3, etc.) for convenience. These are provided as examples and do not limit the present disclosure. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A method for dual-layer quantum communication and computation, comprising:
generating a photon;
establishing a time-bin frame having a period T and a plurality of non-overlapping time bins of duration Δt;
preparing a quantum state of the photon in a time-bin basis and in at least one additional quantum degree of freedom selected from polarization, orbital angular momentum (OAM), and phase, thereby forming a composite quantum state;
routing the photon to a selected emission point of a three-dimensional photonic structure having a plurality of emission points with respective spatial coordinates;
synchronizing a sender and a receiver with a shared timing reference and time-gated detection windows aligned to the time bins; and
emitting the photon from the selected emission point into a quantum channel,
wherein a time-bin state encodes quantum information, and an emission-point coordinate is associated with a spatial symbol and/or non-secret control metadata for protocol processing, and the combination of the time-bin state and emission-point coordinate forms a composite codeword.

Example 2. The method of any example herein, particularly of example 1, wherein establishing the time-bin frame includes transmitting pilot optical pulses or classical sync symbols to align clocks of a sender and a receiver, and wherein the receiver admits detections only within gated windows of width Δt centered on expected bin arrivals.

Example 3. The method of any example herein, particularly of any one of examples 1-2, further comprising transitioning the photon between time bins by applying a variable optical delay equal to an integer multiple of Δt under control of a dynamic coupling module.

Example 4. The method of any example herein, particularly of any one of examples 1-3, wherein the dynamic coupling module comprises an optical switch network and a phase or electro-optic modulator configured to preserve quantum coherence while altering one or both of an arrival time of the photon or a spatial path of the photon.

Example 5. The method of any example herein, particularly of any one of examples 1-4, wherein the three-dimensional photonic structure comprises a double-helix or lattice arrangement, and each emission point corresponds to a distinct spatial-mode (path-mode) basis state associated with a unique spatial coordinate.

Example 6. The method of any example herein, particularly of any one of examples 1-6, further comprising randomizing emission-point selection across the three-dimensional photonic structure according to a pseudorandom sequence to introduce spatial entropy for key distribution.

Example 7. The method of any example herein, particularly of any one of examples 1-6, wherein the composite codeword is decoded at a receiver by: (i) determining the emission-point coordinate (or a spatial port index or spatial symbol associated therewith) to recover non-secret control metadata and/or post-sifting spatial symbol information; and (ii) measuring the quantum state in at least one of the time-bin, polarization, OAM, or phase bases to recover quantum information.

Example 8. The method of any example herein, particularly of any one of examples 1-7, wherein the dual-layer encoding is used for quantum key distribution (QKD), with key material derived from matched-basis quantum measurement outcomes associated with at least one of time-bin states and additional quantum degrees of freedom, and with spatial symbols and/or non-secret control metadata used for protocol processing during sifting and reconciliation.

Example 9. The method of any example herein, particularly of any one of examples 1-8, wherein an untrusted relay node is configured to perform Bell-state measurements (BSMs) on photons received from the sender (Alice) and the receiver (Bob), the photons being prepared in time-bin states and at least one of polarization, OAM, or phase, and wherein a successful BSM event establishes correlations used for key generation without trusting measurement devices at the relay.

Example 10. The method of any example herein, particularly of example 9, wherein the sender and the receiver each randomize emission-point coordinates independently of quantum basis choices, and the relay's BSM results are publicly announced for sifting conditioned on matched time-bin indices.

Example 11. The method of any example herein, particularly of any one of examples 1-10, wherein the time bins carry Gaussian-distributed quadrature values modulated onto an optical carrier and the receiver performs homodyne or heterodyne detection to measure the quadratures, followed by reconciliation and privacy amplification.

Example 12. The method of any example herein, particularly of example 11, wherein the emission-point coordinate indexes pilot and data bins to aid phase tracking and channel estimation in continuous-variable operation.

Example 13. A dual-layer quantum communication system, comprising:
a photon source;
a timing module configured to define a time-bin frame with bin duration Δt and to distribute synchronization to a receiver;
a three-dimensional photonic structure having a plurality of emission points with unique spatial coordinates;
a dynamic coupling network including at least one variable optical delay and an optical switch to transition a photon between time bins and spatial paths;
a modulator configured to prepare a time-bin quantum state and at least one of polarization, OAM, or phase states; and
the receiver comprising time-gated detectors and a spatial decoding module,
wherein the system encodes quantum information in the time-bin state and associates spatial symbols and/or non-secret control metadata with emission-point coordinates for protocol processing.

Example 14. The system of any example herein, particularly of example 13, wherein the three-dimensional photonic structure is a double-helix having discrete emission points distributed along its surface.

Example 15. The system of any example herein, particularly of any one of examples 13-14, wherein a controller assigns emission-point coordinates according to a pseudorandom sequence synchronized with the receiver.

Example 16. The system of any example herein, particularly of any one of examples 13-15, further comprising an untrusted relay node configured to perform Bell-state measurements for MDI-QKD operation.

Example 17. The system of any example herein, particularly of any one of examples 13-16, wherein the timing module supports continuous-variable time-bin operation with homodyne/heterodyne detection at the receiver.

Example 18. The system of any example herein, particularly of any one of examples 13-17, wherein the dynamic coupling network comprises a fiber-based optical delay line having a length corresponding to an integer multiple of c·Δt, and wherein the optical switch selectively couples the photon into the delay line to shift the photon from a first time bin to a second time bin separated by the integer multiple of Δt.

Example 19. The system of any example herein, particularly of any one of examples 13-18, wherein the modulator comprises an unbalanced Mach-Zehnder interferometer (UMZI) having a path length difference Δl=c·Δt, and an electro-optic phase modulator disposed in one arm of the UMZI to prepare a time-bin qubit state α|e [symbol] +βe\hat{ }(iφ)|l [symbol] , where |e [symbol] and |l [symbol] denote early and late time-bin modes and φ is a controllable phase.

Example 20. The system of any example herein, particularly of any one of examples 13-19, wherein the receiver comprises a second unbalanced Mach-Zehnder interferometer configured to interfere the early and late time-bin modes, and at least two single-photon detectors disposed at output ports of the second UMZI to measure the time-bin state in a superposition basis.

Example 21. A method for dual-layer quantum communication and computation, comprising:
generating a photon;
establishing a time-bin frame having a period T and a plurality of non-overlapping time bins of duration Δt;
preparing a quantum state of the photon in a time-bin basis and in at least one additional quantum degree of freedom selected from polarization, orbital angular momentum (OAM), and phase, thereby forming a composite quantum state;
routing the photon to a selected emission point of a three-dimensional photonic structure having a plurality of emission points with respective spatial coordinates;
synchronizing a sender and a receiver with a shared timing reference and time-gated detection windows aligned to the time bins; and
emitting the photon from the selected emission point into a quantum channel,
wherein a time-bin state encodes quantum information, an emission-point coordinate associated with spatial symbol and/or non-secret control metadata, and a combination of the time-bin state and emission-point coordinate forms a composite codeword.

Example 22. The method of any example herein, particularly of example 21, wherein establishing the time-bin frame includes transmitting pilot optical pulses or classical synchronization symbols to align clocks of the sender and the receiver, and wherein the receiver admits detections only within gated windows of width Δt centered on expected bin arrivals.

Example 23. The method of any example herein, particularly of any one of examples 21-22, wherein the three-dimensional photonic structure comprises a double-helix or lattice arrangement, and each emission point corresponds to a distinct spatial mode basis state associated with a unique spatial coordinate.

Example 24. The method of any example herein, particularly of any one of examples 21-23, wherein preparing the quantum state of the photon comprises using an unbalanced Mach-Zehnder interferometer or a programmable optical delay network to generate the time-bin state.

Example 25. The method of any example herein, particularly of any one of examples 21-24, wherein the dual-layer quantum communication and computation is used for quantum key distribution, key bits derived from matched-basis quantum measurement outcomes associated with time-bin states and/or additional quantum degrees of freedom.

Example 26. A dual-layer quantum communication system, comprising:
a photon source;
a timing module configured to define a time-bin frame with bin duration Δt and to distribute synchronization to a receiver;
a three-dimensional photonic structure having a plurality of emission points with unique spatial coordinates;
a dynamic coupling network including at least one variable optical delay and an optical switch configured to transition a photon between time bins and spatial paths;
a modulator configured to prepare a time-bin quantum state and at least one of polarization, orbital angular momentum (OAM), or phase states; and
the receiver comprising time-gated detectors and a spatial decoding module,
wherein the system encodes quantum information in the time-bin state and associates spatial symbols and/or non-secret control metadata with emission-point coordinates.

Example 27. The system of any example herein, particularly of example 26, wherein the three-dimensional photonic structure is a double-helix having discrete emission points distributed along its surface.

Example 28. The system of any example herein, particularly of any one of examples 26-27, wherein the dynamic coupling network comprises a fiber-based optical delay line having a length corresponding to an integer multiple of c·Δt where c is the speed of light.

Example 29. The system of any example herein, particularly of any one of examples 26-28, wherein the modulator comprises an unbalanced Mach-Zehnder interferometer having a path-length difference Δl=c·Δt and an electro-optic phase modulator disposed in one arm where c is the speed of light.

Example 30. A method for dual-layer quantum communication and computation, comprising:
generating a photon;
establishing a time-bin frame having a period T and a plurality of non-overlapping time bins of duration Δt;
preparing a quantum state of the photon in a time-bin basis and in at least one additional quantum degree of freedom selected from polarization, orbital angular momentum (OAM), phase, or frequency, thereby forming a composite quantum state;
routing the photon to a selected spatial mode of a photonic structure having a plurality of distinguishable spatial modes;
synchronizing a sender and a receiver; and
emitting the photon into a quantum channel,
wherein information is encoded jointly using a temporal coordinate associated with the time-bin basis and a spatial coordinate associated with the selected spatial mode.

Example 31. The method of any example herein, particularly of example 30, wherein the time-bin basis comprises more than two temporal modes within a frame, such that a photon occupies one of N discrete time bins or a coherent superposition thereof, where N≥3.

Example 32. The method of any example herein, particularly of any one of examples 30-31, wherein the time-bin basis is implemented using pulse-position modulation, differential delay encoding, or gated temporal detection windows.

Example 33. The method of any example herein, particularly of any one of examples 30-32, wherein the temporal encoding comprises quasi-discrete or continuous temporal modes defined by shaped optical wavepackets or time-frequency basis functions.

Example 34. The method of any example herein, particularly of any one of examples 30-33, wherein the spatial coordinate corresponds to a waveguide index, spatial mode label, multi-core fiber core, free-space propagation path, or integrated photonic channel.

Example 35. The method of any example herein, particularly of any one of examples 30-34, wherein the photonic structure comprises a planar photonic circuit, a waveguide mesh, a lattice, or a multi-core optical fiber rather than discrete emission points.

Example 36. The method of any example herein, particularly of any one of examples 30-35, wherein the photon is prepared in a coherent superposition of two or more spatial modes, thereby encoding quantum information in a spatial-mode basis.

Example 37. The method of any example herein, particularly of any one of examples 30-36, wherein preparing the time-bin quantum state is performed using an unbalanced interferometer, a programmable photonic mesh, or a tunable optical delay network.

Example 38. The method of any example herein, particularly of any one of examples 30-37, wherein measurement of the time-bin quantum state is performed using time-resolved detection without interferometric recombination.

Example 39. The method of any example herein, particularly of any one of examples 30-38, wherein synchronization between the sender and the receiver is achieved using pilot tones, classical metadata exchange, round-trip timing calibration, or post-processing temporal correlation.

Example 40. The method of any example herein, particularly of any one of examples 30-39, wherein temporal alignment is adaptively adjusted based on detected photon arrival statistics.

Example 41. A dual-layer quantum communication system, comprising:
a photon source;
a timing module configured to define a time-bin frame;
a photonic structure providing a plurality of distinguishable spatial modes;
a routing network configured to direct photons to selected spatial modes;
a modulator configured to prepare time-bin quantum states and at least one additional quantum degree of freedom; and
a receiver configured to resolve both temporal and spatial coordinates of received photons.

Example 42. The system of any example herein, particularly of example 41, wherein the photonic structure comprises an integrated photonic circuit implementing spatial addressing via waveguide indices.

Example 43. The system of any example herein, particularly of any one of examples 41-42, wherein the timing module supports multi-level temporal encoding with more than two time bins per frame.

Example 44. The system of any example herein, particularly of any one of examples 41-43, wherein the routing network comprises an optical switch network and a variable optical delay configured to alter one or both of a spatial path or an arrival time of a photon.

Example 45. The system of any example herein, particularly of any one of examples 41-44, wherein the receiver is configured to resolve spatial modes using a mode demultiplexer and to resolve temporal modes using time-gated detection.

Example 46. A method for multi-dimensional quantum communication and information processing, comprising:
generating one or more photons;
encoding information in each photon using a temporal coordinate defined by a time-bin structure and a spatial coordinate defined by a selectable spatial mode of a photonic structure;
preparing each photon in at least one quantum degree of freedom selected from polarization, orbital angular momentum (OAM), phase, frequency, or quadrature amplitude;
routing the photons through a quantum channel; and
processing received photons by resolving at least the temporal coordinate, the spatial coordinate, and the quantum degree of freedom,
wherein the temporal coordinate, the spatial coordinate, and the quantum degree of freedom together form a composite information space used for quantum communication, computation, or storage.

Example 47. The method of any example herein, particularly of example 46, wherein photons prepared by a first sender and a second sender are transmitted to an untrusted relay node configured to perform Bell-state measurements.

Example 48. The method of any example herein, particularly of example 47, wherein each sender independently randomizes temporal coordinates, spatial coordinates, and quantum-state preparation bases.

Example 49. The method of any example herein, particularly of example 47, wherein successful Bell-state measurement outcomes are publicly announced and used by the senders to derive correlated key material without trusting the relay node.

Example 50. The method of any example herein, particularly of example 46, wherein encoding the photon comprises modulating Gaussian-distributed quadrature values onto an optical carrier.

Example 51. The method of any example herein, particularly of example 50, wherein the temporal coordinate and the spatial coordinate are used to index signal states, decoy states, or pilot states for channel estimation and phase tracking.

Example 52. The method of any example herein, particularly of example 50, wherein the received photons are measured using homodyne or heterodyne detection followed by reconciliation and privacy amplification.

Example 53. The method of any example herein, particularly of example 46, wherein synchronization between communicating entities is achieved without a shared clock by post-processing temporal correlations of detected photons.

Example 54. The method of any example herein, particularly of example 46, wherein temporal alignment is adaptively adjusted using statistical inference or machine-learning-assisted estimation based on detected photon arrival patterns.

Example 55. The method of any example herein, particularly of example 46, wherein temporal coordinates correspond to computation cycles and spatial coordinates correspond to logical quantum modes.

Example 56. The method of any example herein, particularly of example 55, wherein routing photons among spatial modes across successive temporal coordinates implements a sequence of quantum logic operations.

Example 57. The method of any example herein, particularly of example 46, further comprising storing quantum information by routing photons into delay lines or quantum memory elements addressed by temporal coordinates.

Example 58. The method of any example herein, particularly of example 57, wherein spatial coordinates provide redundancy for error resilience or fault tolerance during storage.

Example 59. The method of any example herein, particularly of example 46, further comprising performing error detection or error correction across temporal, spatial, and quantum-state dimensions.

Example 60. A multi-dimensional quantum communication and processing platform, comprising:
a photon generation subsystem;
a timing and synchronization subsystem configured to define temporal encoding coordinates;
a photonic structure providing a plurality of selectable spatial modes;
a modulation subsystem configured to encode photons in one or more quantum degrees of freedom;
a routing subsystem configured to direct photons among spatial modes and temporal slots; and
a detection subsystem configured to resolve temporal, spatial, and quantum-state information,
wherein the platform supports quantum key distribution, quantum computation, or quantum information storage using composite temporal-spatial-quantum encoding.

Example 61. The platform of any example herein, particularly of example 60, wherein the photonic structure comprises a three-dimensional arrangement, a planar photonic circuit, a waveguide mesh, or a multi-core optical fiber.

Example 62. The platform of any example herein, particularly of any one of examples 60-61, wherein the routing subsystem comprises optical switches, tunable couplers, or variable optical delay elements configured to alter temporal or spatial coordinates.

Example 63. The platform of any example herein, particularly of any one of examples 60-62, wherein the detection subsystem comprises time-gated single-photon detectors, mode demultiplexers, interferometric receivers, or homodyne detectors.

Example 64. The platform of any example herein, particularly of any one of examples 60-63, further comprising a classical control subsystem configured to coordinate modulation, routing, synchronization, and post-processing.

Example 65. The platform of any example herein, particularly of any one of examples 60-64, wherein the platform is configured to dynamically switch between quantum key distribution, quantum computation, and quantum information storage modes.

1. A method for dual-layer quantum communication and computation, comprising:
generating a photon;
establishing a time-bin frame having a period T and a plurality of non-overlapping time bins of duration Δt;
preparing a quantum state of the photon in a time-bin basis and in at least one additional quantum degree of freedom selected from polarization, orbital angular momentum (OAM), and phase, thereby forming a composite quantum state;
routing the photon to a selected emission point of a three-dimensional photonic structure having a plurality of emission points with respective spatial coordinates;
synchronizing a sender and a receiver with a shared timing reference and time-gated detection windows aligned to the time bins; and
emitting the photon from the selected emission point into a quantum channel,
wherein a time-bin state encodes quantum information, and an emission-point coordinate is associated with a spatial symbol and/or non-secret control metadata for protocol processing, and a combination of the time-bin state and emission-point coordinate forms a composite codeword.

2. The method of claim 1, wherein establishing the time-bin frame includes transmitting pilot optical pulses or classical synchronization symbols to align clocks of the sender and the receiver, and wherein the receiver admits detections only within gated windows of width Δt centered on expected bin arrivals.

3. The method of claim 1, wherein the three-dimensional photonic structure comprises a double-helix or lattice arrangement, and each emission point corresponds to a distinct spatial mode basis state associated with a unique spatial coordinate or spatial mode index.

4. The method of claim 1, wherein preparing the quantum state of the photon comprises using an unbalanced Mach-Zehnder interferometer or a programmable optical delay network to generate the time-bin state.

5. The method of claim 1, wherein the dual-layer quantum communication is used for quantum key distribution, with key material derived from matched-basis quantum measurement outcomes associated with at least one of time-bin states or additional quantum degrees of freedom.

6. A dual-layer quantum communication system, comprising:
a photon source;
a timing module configured to define a time-bin frame with bin duration Δt and to distribute synchronization to a receiver;
a three-dimensional photonic structure having a plurality of emission points with unique spatial coordinates;
a dynamic coupling network including at least one variable optical delay and an optical switch configured to transition a photon between time bins and spatial paths;
a modulator configured to prepare a time-bin quantum state and at least one of polarization, orbital angular momentum (OAM), or phase states; and
the receiver comprising time-gated detectors and a spatial decoding module,
wherein the system encodes quantum information in the time-bin state and associates spatial symbols and/or non-secret control metadata with emission-point coordinates for protocol processing.

7. The system of claim 6, wherein the three-dimensional photonic structure is a double-helix having discrete emission points distributed along its surface.

8. The system of claim 6, wherein the dynamic coupling network comprises a fiber-based optical delay line having a length corresponding to an integer multiple of c·Δt where c is the speed of light.

9. The system of claim 6, wherein the modulator comprises an unbalanced Mach-Zehnder interferometer having a path-length difference Δl=c·Δt and an electro-optic phase modulator disposed in one arm where c is the speed of light.

10. A method for dual-layer quantum communication and computation, comprising:
generating a photon;
establishing a time-bin frame having a period T and a plurality of non-overlapping time bins of duration Δt;
preparing a quantum state of the photon in a time-bin basis and in at least one additional quantum degree of freedom selected from polarization, orbital angular momentum (OAM), phase, or frequency, thereby forming a composite quantum state;
routing the photon to a selected spatial mode of a photonic structure having a plurality of distinguishable spatial modes;
synchronizing a sender and a receiver; and
emitting the photon into a quantum channel,
wherein information is encoded jointly using a temporal coordinate associated with the time-bin basis and a spatial coordinate associated with the selected spatial mode.

11. The method of claim 10, wherein the time-bin basis comprises more than two temporal modes within a frame, such that a photon occupies one of N discrete time bins or a coherent superposition thereof, where N≥3.

12. The method of claim 10, wherein the time-bin basis is implemented using pulse-position modulation, differential delay encoding, or gated temporal detection windows.

13. The method of claim 10, wherein the temporal encoding comprises quasi-discrete or continuous temporal modes defined by shaped optical wavepackets or time-frequency basis functions.

14. The method of claim 10, wherein the spatial coordinate corresponds to a waveguide index, spatial mode label, multi-core fiber core, free-space propagation path, or integrated photonic channel.

15. The method of claim 10, wherein the photonic structure comprises a planar photonic circuit, a waveguide mesh, a lattice, or a multi-core optical fiber rather than discrete emission points.

16. The method of claim 10, wherein the photon is prepared in a coherent superposition of two or more spatial modes, thereby encoding quantum information in a spatial-mode basis.

17. The method of claim 10, wherein preparing the time-bin quantum state is performed using an unbalanced interferometer, a programmable photonic mesh, or a tunable optical delay network.

18. The method of claim 10, wherein measurement of the time-bin quantum state is performed using time-resolved detection without interferometric recombination.

19. The method of claim 10, wherein synchronization between the sender and the receiver is achieved using pilot tones, classical metadata exchange, round-trip timing calibration, or post-processing temporal correlation.

20. The method of claim 10, wherein temporal alignment is adaptively adjusted based on detected photon arrival statistics.

21. A dual-layer quantum communication system, comprising:
a photon source;
a timing module configured to define a time-bin frame;
a photonic structure providing a plurality of distinguishable spatial modes;
a routing network configured to direct photons to selected spatial modes;
a modulator configured to prepare time-bin quantum states and at least one additional quantum degree of freedom; and
a receiver configured to resolve both temporal and spatial coordinates of received photons.

22. The system of claim 21, wherein the photonic structure comprises an integrated photonic circuit implementing spatial addressing via waveguide indices.

23. The system of claim 21, wherein the timing module supports multi-level temporal encoding with more than two time bins per frame.

24. The system of claim 21, wherein the routing network comprises an optical switch network and a variable optical delay configured to alter one or both of a spatial path or an arrival time of a photon.

25. The system of claim 21, wherein the receiver is configured to resolve spatial modes using a mode demultiplexer and to resolve temporal modes using time-gated detection.
